(19) United States
(12) Patent Application Publication
(10) Pub. No.: US 2014/0286436 A1
(43) Pub. Date: Sep. 25, 2014

(54) IMAGE PROCESSING APPARATUS AND IMAGE PROCESSING METHOD

(71) Applicant: Sony Corporation, Tokyo (JP)

(72) Inventor: Kazushi Sato, Kanagawa (JP)

(73) Assignee: SONY CORPORATION, Tokyo (JP)

(21) Appl. No.: 14/361,785

(22) PCT Filed: Jan. 9, 2013
(86) PCT No.: PCT/JP2013/050211

§ 371 Date: May 30, 2014

(30) Foreign Application Priority Data
Jan. 18, 2012 (JP) 2012-008463

(51) Int. Cl. H04N 19/126; H04N 19/60

(52) U.S. Cl. CPC H04N 19/00096; H04N 19/00775
USPC 375/240.18

(57) ABSTRACT

The present disclosure relates to an image processing apparatus and an image processing method in which a deterioration of an image quality of a color difference signal due to the quantization can be suppressed. The image processing apparatus in the present disclosure includes an offset setting unit that sets an offset of a quantization parameter for a color difference signal based on a quantization parameter for a brightness signal according to a size or shape of a unit of transform when an orthogonal transform is performed on image data, or a receiving unit that receives an offset of a quantization parameter for a color difference signal which is set according to a size or a shape of a unit of transform. The present disclosure, for example, can be adapted to an image processing apparatus that processes image data.

### TECHNICAL FIELD

The present disclosure relates to an image processing apparatus and an image processing method, particularly to an image processing apparatus and an image processing method for improving image quality of a color difference signal.

### BACKGROUND ART

In recent years, in treating image information digitally, in order to transmit and accumulate the information with high accuracy, an apparatus based on a method such as MPEG (Moving Picture Expert Group) in which the data is compressed by motion compensation and orthogonal transform such as a discrete cosine transform by utilizing a specific redundancy of the image information, is widespread in information distributions both in the broadcasting station and in ordinary households.

Particularly, MPEG2 (ISO (International Organization for Standardization)/IEC (International Electrotechnical Commission) 13818-2) is defined as a general-purpose image encoding method, and is a standard covering both an interlaced scanning image and a sequential scanning image, and a standard resolution image and a high-definition image, and is currently widely used in a wide range of applications of professional usage and consumer usage. By using the MPEG2 compression method, for example, in a case of an interlaced scanning image of standard resolution having pixels of 720×480, an amount of codes (bit rate) of 4 Mbps to 8 Mbps is assigned, and in a case of an interlaced scanning image of high-resolution having pixels of 1920×1088, an amount of codes (bit rate) of 18 Mbps to 22 Mbps is assigned. Therefore, it is possible to realize a high compression rate and a high image quality.

The MPEG2 has been mainly used in a high-quality coding which is suitable for broadcasting, but has not supported the amount of codes (bit rate) less than that of MPEG1, that is, the coding method of a higher compression rate. By the spread of the mobile terminals, the need for such a coding method has been considered to be increased, and thus, in response to the above matter, a standardization of an MPEG4 image coding method has been performed. The image coding method MPEG4 was approved as the international standard of the image coding by ISO/IEC 14496-2 in December, 1998.

Furthermore, in recent years, for the purpose of image coding for a television conference, a standardization of a standard H.26L (ITU-T (International Telecommunication Union Telecommunication Standardization Sector) Q6/16 VCEG (Video Coding Expert Group)) has progressed. In the H.26L, a larger amount of operation for the coding and decoding is required compared to that in the coding method in the related art such as the MPEG2 or the MPEG4. However, it is known that the high coding efficiency can be realized. In addition, currently, as a part of activities of MPEG4, based on this H.26L, by incorporating features that are not supported by the H.26L, a standardization that realizes the higher coding efficiency is performed as a Joint Model of Enhanced-Compression Video Coding.

As a schedule for the standardization, H.264 and MPEG-4 Part 10 (Advanced Video Coding, hereinafter, described as AVC) has become an international standard in March 2003.

Incidentally, in the AVC, as a unit for coding processing (Coding Unit), a hierarchical structure by macro block and sub-macro block is defined. However, the macro block size of 16 pixels×16 pixels is not optimal with respect to a large image frame such as a UHD (Ultra High definition; 4000 pixels×2000 pixels) which may be a subject of the next generation coding method.

Therefore, in an HEVC (High Efficiency Video Coding) which is a PostAVC coding method, Coding Unit (CU (Coding Unit)) is defined as a unit for coding instead of the macro block (for example, refer to NPL 1).

In the AVC and HEVC, a quantization parameter for a color difference signal is generated by transforming a quantization parameter for a brightness signal using an offset value called choroma_qp_index_offset.

Therefore, for decreasing the amount of coding, the quantization parameter for a color difference signal is also set to a larger value as the block size increases, similar to the case of the quantization parameter for a brightness signal.

### CITATION LIST

### Non Patent Literature

NPL 1: Benjamin Bross, Woo-Jin Han, Jens-Rainer Ohm, Gary J. Sullivan, Thomas Wiegand, “Working Draft 4 of High-Efficiency Video Coding”, JCTVC-F803_d2, Joint Collaborative Team on Video Coding (JCT-VC) of ITU-T SG16 WP3 and ISO/IEC JTC1/SC29/WG11 6th Meeting: Torino, IT, 14-22 Jul., 2011

### SUMMARY OF INVENTION

### Technical Problem

However, in many cases, a block of which a size of the orthogonal transform is large has a uniform image with little motion, and is frequently referenced by a motion vector. For this reason, by setting the quantization parameter for a color difference signal as described above, the block is quantized using a larger quantization parameter as the block is more likely to be referred to, and thus, there is a concern of significant deterioration of image quality of the color difference signal.

The present disclosure is made in consideration of the above situation, and an object thereof is to suppress the deterioration of the image quality of the color difference signal due to the quantization.

### Technical Solution

According to an aspect of the present disclosure, an image processing apparatus includes: an offset setting unit that sets an offset of a quantization parameter for a color difference signal based on a quantization parameter for a brightness signal according to a size or a shape of a unit of transform when an orthogonal transform is performed on image data; and a quantization unit that quantizes an orthogonal transform coefficient of the image data using the quantization parameter for the color difference signal obtained from the quantization parameter for the brightness signal using the offset set by the offset setting unit.

The offset setting unit can set the offset in such a manner that the quantization is performed by the finer quantization step with respect to a larger unit of the transform.

The offset setting unit can set the offset of the larger unit of the transform to a smaller value.

The offset setting unit can set the offset in such a manner that the quantization is performed by the finer quantization step with respect to the orthogonal transform coefficient having a size more likely to be referred to, according to a bit rate of coded data in which the image data is coded.

The offset setting unit can correct an initial value of the offset determined in advance according to the size of the unit of transform.

The offset setting unit can set the offset value with respect to a square unit of transform having a size same as or similar to the unit of transform as the offset with respect to a rectangular unit of transform.

The offset setting unit can set the offset according to the size or shape of the unit of transform when the orthogonal transform is performed on image data.

According to an aspect of the present disclosure, an image processing method by the image processing apparatus includes: setting an offset of a quantization parameter for a color difference signal based on a quantization parameter for a brightness signal according to a size or a shape of a unit of transform when an orthogonal transform is performed on image data, by an offset setting unit; and quantizing an orthogonal transform coefficient of the image data using the quantization parameter for the color difference signal obtained from the quantization parameter for the brightness signal using the offset set by the set offset, by a quantization unit.

According to another aspect of the present disclosure, an image processing apparatus includes: an offset setting unit that sets an offset of a quantization parameter for a color difference signal based on a quantization parameter for a brightness signal according to a size or a shape of a unit of transform when an orthogonal transform is performed on image data; and a reverse quantization unit that reverse quantizes a quantized orthogonal transform coefficient of the image data using the quantization parameter for the color difference signal obtained from the quantization parameter for the brightness signal using the offset set by the offset setting unit.

According to still another aspect of the present disclosure, an image processing method by an image processing apparatus includes: setting an offset of a quantization parameter for a color difference signal based on a quantization parameter for a brightness signal according to a size or a shape of a unit of transform when an orthogonal transform is performed on image data, by an offset setting unit; and reverse quantizing a quantized orthogonal transform coefficient of the image data using the quantization parameter for the color difference signal obtained from the quantization parameter for the brightness signal using the set offset, by a reverse quantization unit.

According to still another aspect of the present disclosure, an image processing apparatus includes: an offset setting unit that sets an offset of a quantization parameter for a color difference signal based on a quantization parameter for a brightness signal according to a size or a shape of a unit of transform when an orthogonal transform is performed on image data; a coding unit that codes the image data; and a transmission unit that transmits the offset set by the offset setting unit and coded data generated by the coding unit.

The transmission unit can transmit the offset set by the offset setting unit as a parameter set of the coded data.

The transmission unit can combine a plurality of offsets set by the offset setting unit into a single set to transmit as the parameter set.

The transmission unit can transmit the offset set by the offset setting unit as a sequence parameter of the coded data.

The transmission unit can transmit the offset set by the offset setting unit as a picture parameter set of the coded data.

The transmission unit can transmit the offset set by the offset setting unit as an adaptation parameter set of the coded data.

The transmission unit can transmit the offset set by the offset setting unit as a slice header of the coded data.

According to still another aspect of the present disclosure, an image processing method by an image processing apparatus includes: setting an offset of a quantization parameter for a color difference signal based on a quantization parameter for a brightness signal according to a size or shape of a unit of transform when an orthogonal transform is performed on image data, by an offset setting unit; coding the image data by a coding unit; and transmitting the set offset and generated coded data, by a transmission unit.

According to still another aspect of the present disclosure, an image processing apparatus includes: a receiving unit that receives an offset of a quantization parameter for a color difference signal based on a quantization parameter for a brightness signal, which is set according to a size or a shape of a unit of transform when an orthogonal transform is performed on image data, and coded data in which the image data is coded; a decoding unit that decodes the coded data received by the receiving unit; and a reverse quantization unit that reverse quantizes a quantized orthogonal transform coefficient of the image data obtained by the coded data being decoded by the decoding unit, using the quantization parameter for the color difference signal obtained from the quantization parameter for the brightness signal using the offset extracted from the coded data received by the receiving unit.

According to still another aspect of the present disclosure, An image processing method by an image processing apparatus includes: receiving an offset of a quantization parameter for a color difference signal based on a quantization parameter for a brightness signal, which is set according to a size or a shape of a unit of transform when an orthogonal transform is performed on image data, and coded data in which the image data is coded, by a receiving unit; decoding the received coded data, by a decoding unit; and reverse quantizing a quantized orthogonal transform coefficient of the image data obtained by the coded data being decoded by the decoding unit, using the quantization parameter for the color difference signal obtained from the quantization parameter for the brightness signal using the offset extracted from the received coded data, by a reverse quantization unit.

In an aspect of the present disclosure, an offset of a quantization parameter for a color difference signal based on a quantization parameter for a brightness signal is set according to a size or a shape of a unit of transform when an orthogonal transform is performed on image data; and an orthogonal transform coefficient of the image data is quantized using the quantization parameter for the color difference signal obtained from the quantization parameter for the brightness signal using the offset set by the offset setting unit.

In another aspect of the present disclosure, an offset of a quantization parameter for a color difference signal based on a quantization parameter for a brightness signal is set according to a size or a shape of a unit of transform when an orthogonal transform is performed on image data; and a quantized orthogonal transform coefficient of the image data is reverse quantized using the quantization parameter for the color difference signal obtained from the quantization parameter for the brightness signal using the offset set by the offset setting unit.

In still another aspect of the present disclosure, an offset of a quantization parameter for a color difference signal based on a quantization parameter for a brightness signal is set according to a size or shape of a unit of transform when an orthogonal transform is performed on image data; the image data is coded; and the set offset and the generated coded data are transmitted.

In still another aspect of the present disclosure, an offset of a quantization parameter for a color difference signal based on a quantization parameter for a brightness signal, which is set according to a size or a shape of a unit of transform when an orthogonal transform is performed on image data, and coded data in which the image data is coded are received; the coded data received by the receiving unit is decoded; and a quantized orthogonal transform coefficient of the image data obtained by the coded data being decoded by the decoding unit is reverse quantized using the quantization parameter for the color difference signal obtained from the quantization parameter for the brightness signal using the offset extracted from the coded data received by the receiving unit.

### Advantageous Effects

According to the present disclosure, an image processing can be performed. Particularly, it is possible to suppress the deterioration of an image quality of a color difference component.

### BRIEF DESCRIPTION OF DRAWINGS

FIG. 1 is a block diagram illustrating an example of a main configuration of an image coding apparatus.

FIG. 2 is a diagram illustrating an example of a relationship between a quantization step and a quantization parameter.

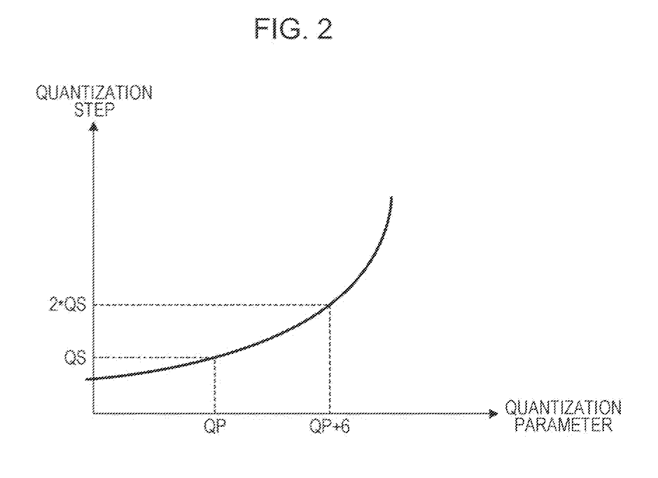

FIG. 3 is a diagram illustrating an example of a relationship between a quantization parameter of a color difference component and a parameter calculated from a quantization parameter of a brightness component.

FIG. 4 is a diagram illustrating a configuration example of a coding unit.

FIG. 5 is a diagram illustrating an example of syntax of a picture parameter set.

FIG. 6 is a diagram illustrating an example of syntax of a transform coefficient.

FIG. 7 is a block diagram illustrating an example of a main configuration example of the orthogonal transform unit and a quantization unit.

FIG. 8 is a diagram illustrating a quantization parameter control example with respect to the color difference signal corresponding to a TU size.

FIG. 9 is a flow chart explaining an example of a flow of coding processing.

FIG. 10 is a flow chart explaining an example of a flow of orthogonal transform quantization processing.

FIG. 11 is a block diagram illustrating an example of a main configuration of an image decoding apparatus.

FIG. 12 is a block diagram illustrating an example of a main configuration of a reverse quantization unit.

FIG. 13 is a flow chart explaining an example of a flow of the decoding processing.

FIG. 14 is a flow chart explaining an example of a flow of a reverse quantization and a reverse orthogonal transform processing.

FIG. 15 is a diagram illustrating an example of a method of multi-viewpoint image coding.

FIG. 16 is a diagram illustrating an example of a main configuration of a multi-viewpoint image coding apparatus to which the present technology is applied.

FIG. 17 is a diagram illustrating an example of a main configuration of a multi-viewpoint image decoding apparatus to which the present technology is applied.

FIG. 18 is a diagram illustrating an example of a hierarchical image coding method.

FIG. 19 is a diagram illustrating an example of a main configuration of a hierarchical image coding apparatus to which the present technology is applied.

FIG. 20 is a diagram illustrating an example of a main configuration of a hierarchical image decoding apparatus to which the present technology is applied.

FIG. 21 is a block diagram illustrating an example of a main configuration of a computer.

FIG. 22 is a block diagram illustrating an example of a main configuration of a television apparatus.

FIG. 23 is a block diagram illustrating an example of a main configuration of a mobile phone.

FIG. 24 is a block diagram illustrating an example of a main configuration of a recording and reproduction machine.

FIG. 25 is a block diagram illustrating an example of a main configuration of an imaging apparatus.

FIG. 26 is a block diagram illustrating an example of using a scalable coding.

FIG. 27 is a block diagram illustrating another example of using a scalable coding.

FIG. 28 is a block diagram illustrating still another example of using a scalable coding.

### DESCRIPTION OF EMBODIMENTS

Hereinafter, the modes for carrying out the present disclosure (hereinafter, referred to as embodiments) will be described. The description will be made in the following order.

1. First embodiment (an image encoding apparatus)
2. Second embodiment (an image decoding apparatus)
3. Third embodiment (a multi-view image coding apparatus and multi-view image decoding apparatus)
4. Fourth embodiment (a hierarchical image coding apparatus and a hierarchical image decoding apparatus)
5. Fifth embodiment (a computer)
6. Sixth embodiment (a television receiver)
7. Seventh embodiment (a mobile phone)
8. Eighth embodiment (a record reproduction apparatus)
9. Ninth embodiment (an imaging apparatus)
10. Application example of a scalable coding

### 1. First Embodiment

### Image Coding Apparatus

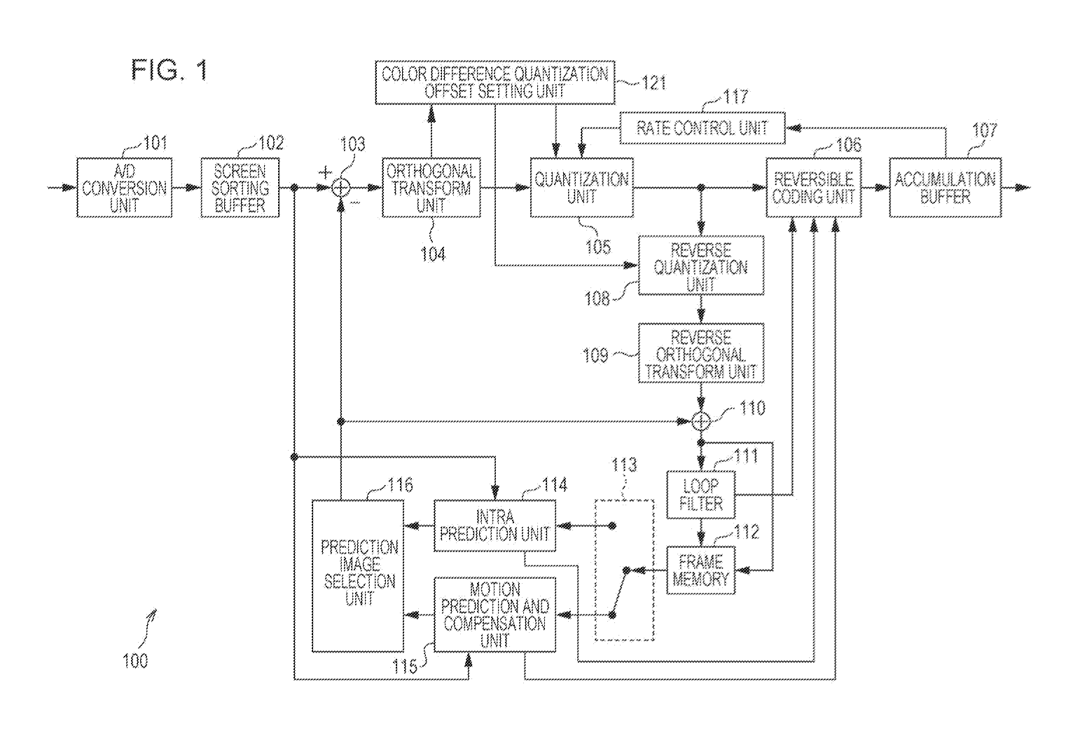

FIG. 1 is a block diagram illustrating an example of a main configuration of an image coding apparatus which is an image processing apparatus to which the present technology is applied.

An image coding apparatus 100 illustrated in FIG. 1, for example, performs a coding of image data of moving pictures, such as a High Efficiency Video Coding method (HEVC), H.264, and an Moving Picture Experts (MPEG) 4 Group 10 (Advanced Video Coding) (AVC)) coding method.

As illustrated in FIG. 1, the image coding apparatus 100 includes an A/D conversion unit 101, a screen sorting buffer 102, a calculation unit 103, an orthogonal transform unit 104, a quantization unit 105, a reversible coding unit 106, and an accumulation buffer 107. The image coding apparatus 100 includes a reverse quantization unit 108, a reverse orthogonal transform unit 109, a calculation unit 110, a loop filter 111, a frame memory 112, a selection unit 113, an intra prediction unit 114, a motion prediction and compensation unit 115, a prediction image selection unit 116, and a rate control unit 117.

The A/D conversion unit 101 A/D converts the input image data, and supplies the converted image data (digital data) to the screen sorting buffer 102 to be stored. The screen sorting buffer 102 sorts the stored frame of image from an order of display to an order of frames for coding based on a group of picture (GOP), and supplies the image sorted in the order of frames to the calculation unit 103. The screen sorting buffer 102 supplies each frame image to the calculation unit 103 for each predetermined partial region which is a processing unit of the coding processing (coding unit).

The screen sorting buffer 102 supplies the image sorted in the order of frames to the intra prediction unit 114 and the motion prediction and compensation unit 115 similarly for each partial region.

The calculation unit 103, from the image read out from the screen sorting buffer 102, subtracts a prediction image supplied from the intra prediction unit 114 and the motion prediction and compensation unit 115 via the prediction image selection unit 116, and outputs the difference information to the orthogonal transform unit 104. For example, in a case of an image on which an intra coding is performed, the calculation unit 103, from the image read out from the screen sorting buffer 102, subtracts the prediction image supplied from the intra prediction unit 114. In addition, for example, in a case of an image on which an inter-coding is performed, the calculation unit 103, from the image read out from the screen sorting buffer 102, subtracts the prediction image supplied from the motion prediction and compensation unit 115.

The orthogonal transform unit 104 performs an orthogonal transform such as a discrete cosine transform or a Karhunen-Loeve transform with respect to the difference information supplied from the calculation unit 103. The method of the orthogonal transform is optional. The orthogonal transform unit 104 supplies a transform coefficient obtained by the orthogonal transform to the quantization unit 105.

The quantization unit 105 quantizes the transform coefficient supplied from the orthogonal transform unit 104. The quantization unit 105 supplies the quantized orthogonal transform to the reversible coding unit 106.

The reversible coding unit 106 codes the transform coefficient quantized in the quantization unit 105 in an arbitrary coding method, and generates coded data (bit stream). Since coefficient data is quantized under the control of the rate control unit 117, an amount of codes of the coded data is a target value set by the rate control unit 117 (or similar to the target value).

In addition, the reversible coding unit 106 acquires intra prediction information including information indicating a mode of the intra prediction from the intra prediction unit 114, and acquires inter prediction information including information indicating a mode of inter-prediction, motion vector information, and the like from the motion prediction and compensation unit 115. The reversible coding unit 106 acquires a filter coefficient, or the like used in the loop filter 111.

The reversible coding unit 106 codes this various information using an arbitrary coding method to include (multiplex) the coded data (bit stream). The reversible coding unit 106 supplies the coded data generated in this manner to the accumulation buffer 107 to accumulate.

A variable-length coding, an arithmetic coding, or the like is included in the coding method of the reversible coding unit 106. As the variable-length coding, a H.264/AVC Context-Adaptive Variable Length Coding (CAVLAC) can be exemplified. As the arithmetic coding, a Context-Adaptive Binary Arithmetic Coding (CABAC) can be exemplified.

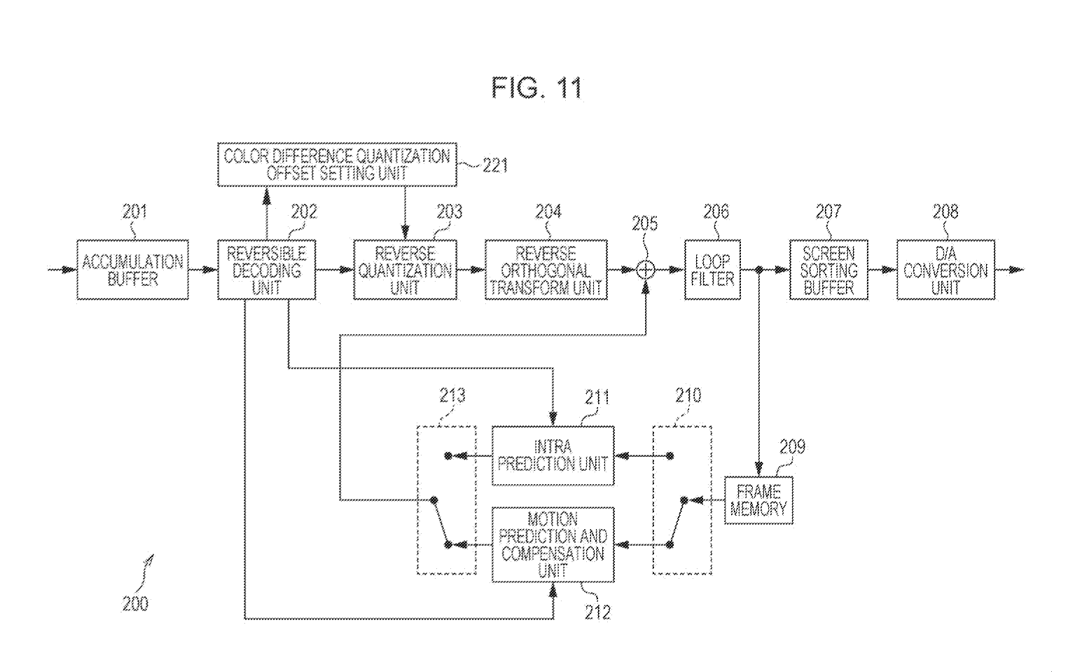

The accumulation buffer 107 temporarily holds the coded data supplied from the reversible coding unit 106. The accumulation buffer 107 outputs the held coded data to, for example, a recording apparatus (recording medium), a transmission path, or the like as bit stream in next stage (not illustrated) at a predetermined timing. In other words, the various pieces of coded information are supplied to an apparatus (hereinafter, referred to as decoding side apparatus) (for example, an image decoding apparatus 200 described below in FIG. 11) that decodes the coded data obtained by coding the image data by the image coding apparatus 100.

In addition, the transform coefficient quantized in the quantization unit 105 is also supplied to the reverse quantization unit 108. The reverse quantization unit 108 reverse quantizes the quantized transform coefficient by the method corresponding to the quantization of the quantization unit 105. The reverse quantization unit 108 supplies the obtained transform coefficient to the reverse orthogonal transform unit 109.

The reverse orthogonal transform unit 109 performs the reverse orthogonal transform on the transform coefficient supplied from the reverse quantization unit 108 by the method corresponding to the orthogonal transform of the orthogonal transform unit 104. The output of the reverse orthogonal transform (difference information locally restored) is supplied to the calculation unit 110.

The calculation unit 110 adds a prediction image supplied from the intra prediction unit 114 or the motion prediction and compensation unit 115 via the prediction image selection unit 116 to the result of the reverse orthogonal transform supplied from the reverse orthogonal transform unit 109, that is, the locally restored difference information, and obtains a locally reconstructed image (hereinafter, referred to as reconstructed image). The reconstructed image is supplied to the loop filter 111 or the frame memory 112.

The loop filter 111 includes a deblocking filter or an adaptive loop filter to perform an appropriate filter processing with respect to the reconstructed image supplied from the calculation unit 110. For example, the loop filter 111 removes the blocking distortion of the reconstructed image by performing the deblocking processing with respect to the reconstructed image. In addition, for example, the loop filter 111 performs the improvement of the image quality by performing the loop filter processing using a Wiener filter with respect to the processing result of the deblocking filter (the reconstructed image on which the removing of the blocking distortion is performed).

The loop filter 111 may further perform another arbitrary filter processing with respect to the reconstructed image. In addition, the loop filter 111 may supply information such as a filter coefficient used in the filter processing as necessary to the reversible coding unit 106 to be coded.

The loop filter 111 supplies the result of the filter processing (hereinafter, referred to as decoded image) to the frame memory 112.

The frame memory 112 stores both the reconstructed image supplied from the calculation unit 110 and the decoded image supplied from the loop filter 111. The frame memory 112 supplies the stored reconstructed image to the intra prediction unit 114 via the selection unit 113 at a predetermined timing or based on a request from outside such as the intra prediction unit 114. In addition, the frame memory 112 supplies the stored decoded image to the motion prediction and compensation unit 115 via the selection unit 113 at a predetermined timing or based on a request from outside such as the motion prediction and compensation unit 115.

The selection unit 113 indicates the supply destination of the image output from the frame memory 112. For example, in a case of intra prediction, the selection unit 113 reads out the image that is not filter processed (reconstructed image) from the frame memory 112, and supplies the reconstructed image to the intra prediction unit 114 as a peripheral pixel.

In addition, for example, in a case of intra prediction, the selection unit 113 reads out the image that is filter processed (decoded image) from the frame memory 112, and supplies the decoded image to the motion prediction and compensation unit 115 as a reference image.

When the intra prediction unit 114 acquires the image (peripheral image) positioned in a peripheral region subjected to the processing from the frame memory 112, the intra prediction unit 114 performs the intra prediction (prediction in the image) by which the prediction image is generated, using a pixel value of the peripheral image basically with the prediction unit (PU) as a unit of processing. The intra prediction unit 114 performs this intra prediction in a plurality of modes (intra prediction modes) prepared in advance.

In other words, the intra prediction unit 114 generates the prediction image in the intra prediction modes of all the candidates, evaluates a cost function value of each prediction image using the input image supplied from the screen sorting buffer 102, and selects the optimal mode. When the optimal intra prediction mode is selected, the intra prediction unit 114 supplies the prediction image generated in the optimal mode to the prediction image selection unit 116.

In addition, the intra prediction unit 114 appropriately supplies intra prediction information including the information related to the intra prediction such as the optimal intra prediction mode to the reversible coding unit 106 to be coded.

The motion prediction and compensation unit 115 performs the motion prediction (inter prediction) basically with the PU (inter PU) as the unit of processing using the input image supplied from the screen sorting buffer 102 and the reference image supplied from the frame memory 112, performs a motion compensation processing according to the detected motion vector, and generates a prediction image (inter prediction image information). The motion prediction and compensation unit 115 performs such inter prediction in a plurality of modes (inter prediction modes) prepared in advance.

In other words, the motion prediction and compensation unit 115 generates the prediction image in the inter prediction modes of all the candidates, evaluates a cost function value of each prediction image, and selects an optimal mode. When the optimal inter prediction mode is selected, the motion prediction and compensation unit 115 supplies the prediction image generated in the optimal mode to the prediction image selection unit 116.

In addition, the motion prediction and compensation unit 115 supplies inter prediction information including the information related to the inter prediction such as the optimal inter prediction mode to the reversible coding unit 106 to be coded.

The prediction image selection unit 116 selects the supplier of the prediction image supplied to the calculation unit 103 or the calculation unit 110. For example, in a case of the intra coding, the prediction image selection unit 116 selects the intra prediction unit 114 as the supplier of the prediction image, and supplies the prediction image supplied from the intra prediction unit 114 to the calculation unit 103 or the calculation unit 110. In addition, for example, in a case of inter coding, prediction image selection unit 116 selects the motion prediction and compensation unit 115 as the supplier of the prediction image, and supplies the prediction image supplied from the motion prediction and compensation unit 115 to the calculation unit 103 or the calculation unit 110.

The rate control unit 117 controls the rate of a quantization operation of the quantization unit 105 based on an amount of codes of the coded data accumulated in the accumulation buffer 107 such that overflow or underflow does not occur.

The image coding apparatus 100 includes a color difference quantization offset setting unit 121.

The orthogonal transform processing of the orthogonal transform unit 104 is performed for each region (unit of orthogonal transform, transform unit, or region referred to as TU (transform unit)) having a predetermined size. The size of unit of orthogonal transform (transform unit) is selected from a plurality of candidates prepared in advance. In other words, the orthogonal transform unit 104 performs the orthogonal transform for each size as the transform unit, and selects the size in which the cost function value is smallest (in which the amount of codes is smallest) as the size of the transform unit (referred to as optimal TU size).

The orthogonal transform unit 104 supplies the orthogonal transform coefficient obtained by the orthogonal transform processing performed for each transform unit of the optimal TU size to the quantization unit 105. In addition, the orthogonal transform unit 104 supplies the information relating to the optimal TU size to the color difference quantization offset setting unit 121.

The color difference quantization offset setting unit 121 sets a chroma_qp_index_offset which is an offset value of a quantization parameter for the color difference signal with a quantization parameter for a brightness signal as the reference, depending on the optimal TU size. The color difference quantization offset setting unit 121 supplies the chroma_qp_index_offset set in this way to the quantization unit 105 and the reverse quantization unit 108.

The quantization unit 105 acquires the quantization parameter for the color difference signal using the chroma_qp_index_offset supplied from the color difference quantization offset setting unit 121, and quantizes the orthogonal transform coefficient of the color difference signal supplied from the orthogonal transform unit 104 using the quantization parameter for the color difference signal.

The reverse quantization unit 108 acquires the quantization parameter for the color difference signal using the chroma_qp_index_offset supplied from the color difference quantization offset setting unit 121, and quantizes the quantization data of the color difference signal (quantized transform coefficient) supplied from the quantization unit 105 using the quantization parameter for the color difference signal.

### <Quantization Parameter>

Next, the quantization will be described. The quantization unit 105 performs the quantization that is a process of rounding to an integer value the result of dividing the coefficient data by the quantization step. The quantization unit 105 can decrease the coefficient value by the quantization. Therefore, the image coding apparatus 100 can decrease the amount of codes by coding the coefficient (quantization value) of the quantization result to be smaller than that in a case of coding the orthogonal transform coefficient before the quantization.

In other words, it is possible to adjust the amount of codes by the size of the quantization step. Therefore, it is possible to control the bit stream rate by controlling the size of the quantization step.

At the time of reverse quantization, the size of quantization step same as the size of the quantization step used in the quantization is needed. In the AVC or HEVC, the quantization parameter instead of the quantization step is transmitted to the apparatus in the decoding side. A predetermined relationship between the quantization step (QS) and the quantization parameter (QP) is defined in advance. For example, in a case of the AVC, the relationship such as below-described Formula (1) is defined.

$$\begin{matrix}[ Math . 1 ] & \\ \frac{QS ( QP + 6 )}{QS ( QP )} = 2 & ( 1 )\end{matrix}$$

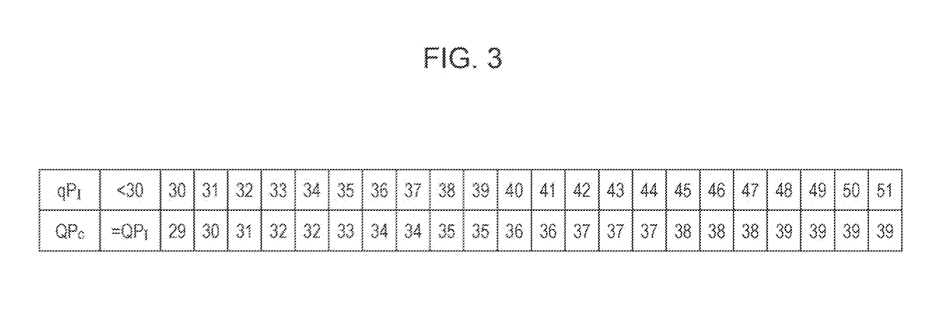

FIG. 3 is a diagram illustrating an example of the relationship between the quantization step (QS) and the quantization parameter (QP) as a graph. As illustrated in FIG. 3, when the quantization parameter increases by 6, the quantization step is doubled.

In addition, according to the relationship described above, the range of the acquirable value of the quantization step can be defined in advance in accordance with the desired range of the quantization step. For example, in a case of AVC, values of zero to 51 are defined as the values of the quantization parameter such that the maximum value of the quantization step becomes 256 times the minimum value of the quantization step.

### <Quantization of the Color Difference Signal>

Next, the quantization processing with respect to the color difference signal will be described.

The quantization parameter QP_{C} with respect to the color difference signal is given as the table illustrated in FIG. 3 according to the quantization parameter QP_{Y} with respect to the brightness signal and a predetermined quantization parameter QP_{I}. The parameter QP_{I} is calculated as below-described Formula (2) using a parameter called chroma_qp_index_offset which is the offset value of quantization parameter for the color difference signal with the quantization parameter for the brightness signal as the reference that is included in the picture parameter set.

[Math. 2]

QP_{I}=Clip3(0,51,QP_{Y}+chroma_{—}qp_index_offset) (2)

Therefore, the user can control the quantization value with respect to the color difference signal by adjusting the value of chroma_qp_index_offset.

In a case of the high profile or higher, it is possible to set chroma_qp_index_offset independently with respect to each of the Cb signal and the Cr signal.

### <Coding Unit>

Incidentally, in the AVC, as a processing unit of coding (Coding Unit), a hierarchical structure by a macro block and a sub-macro block is regulated. However, making the macro block size 16×16 pixels is not optimal with respect to the large image frame such as UHD (ultra high definition; 4000×2000 pixels) which will be a subject of the next generation coding method.

Therefore, in the high efficiency video coding (HVEC) which will be a PostAVC coding method, a Coding Unit (CU) is regulated as the unit of coding instead of the macro block.

The Coding Unit (CU) is also called a coding tree block (CTB), plays a role similar to that of the macro block in AVC, and is a partial region of the multi-layer structure of the image of the picture unit. In other words, the CU is the unit of coding processing (coding unit). The size of the CU is not fixed while the size of the macro block is fixed to 16×16 pixels, and is designated in the image compression information for each sequence.

Particularly, the CU having the largest size is called a largest coding unit (LCU), and the CU having the smallest size is called a smallest coding unit (SCU). In other words, the LCU is the largest coding unit and the SCU is the smallest coding unit. For example, in a sequence parameter set included in the image compression information, the size of the region is designated, but respectively is a square and is limited to the size represented by the exponentiation of 2. In other words, each region in which the CU of a certain layer (a square) is divided into four of 2×2 is the CU of one layer (square) below.

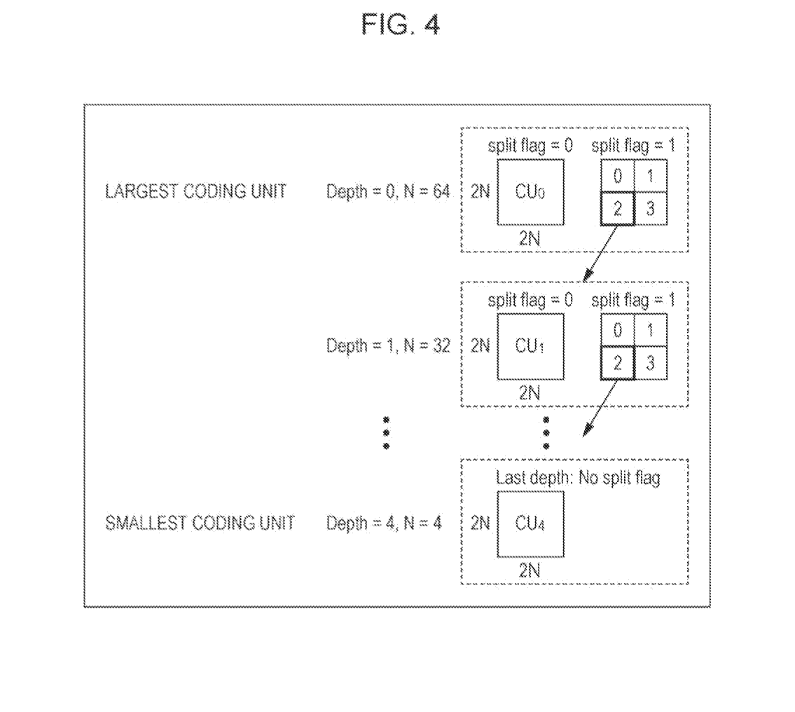

In FIG. 4, an example of Coding Unit defined in the HEVC is illustrated. In the example illustrated in FIG. 4, a size of the LCU is 128 (2N(N=64)), and the largest layer depth is 5 (depth=4). In a case where a value of split_flag is “1”, the CU having a size of 2N×2N is divided into the CU having a size of N×N of which a layer is one layer below.

The CU is divided into a prediction unit (PU) that is a region (a partial region of an image in a unit of picture) which is a unit of the intra or inter prediction processing, and is divided into a transform unit (TU) that is a region (a partial region of an image in a unit of picture) which is a unit of orthogonal transform processing.

In a case of the PU of the inter prediction (inter prediction unit), four kinds of sizes of 2N×2N, 2N×N, N×2N, and N×N can be set with respect to the CU having a size of 2N×2N. In other words, with respect to a CU, it is possible to define a PU having the same size as the CU, two PUs in which the CU is divided into two vertically or horizontally, or four PUs in which the CU is respectively divided into two vertically and horizontally.

The image coding apparatus 100 performs each processing related to the coding with the partial region of the image of the picture unit as the unit of processing. Hereinafter, a case where image coding apparatus 100 performs the coding with a CU defined in the HEVC as a coding unit will be described. In other words, LCU is the largest coding unit and the SCU is the smallest coding unit. However, the unit of processing of each coding processing by the image coding apparatus 100 is not limited to this, but is optional. For example, the macro block or the sub-macro block defined in the AVC may be used as the unit of processing.

In the description below, “(partial) region” includes all of the above-described various regions (for example, the macro block, the sub-macro block, the LCU, the CU, the SCU, the PU, and the TU) (or may include any of them). Of course, a unit other than the above-described may be included, and a unit that cannot be included according to the content of the description may be appropriately excluded.

### <Syntax Related to the Quantization Parameter>

As described above, the quantization parameter (QP) used in the quantization in the apparatus of coding side is transmitted to the apparatus of decoding side. For example, in a case of HEVC, it is possible to transmit the quantization parameter QP in the unit of CU. As described above, the CU has a hierarchical structure, and it is possible to form the CUs having a plurality of sizes in the LCU. Among these, the image coding apparatus 100 can cause the quantization parameter regarding only the CUs having sizes equal to or larger than arbitrary sizes to be transmitted.

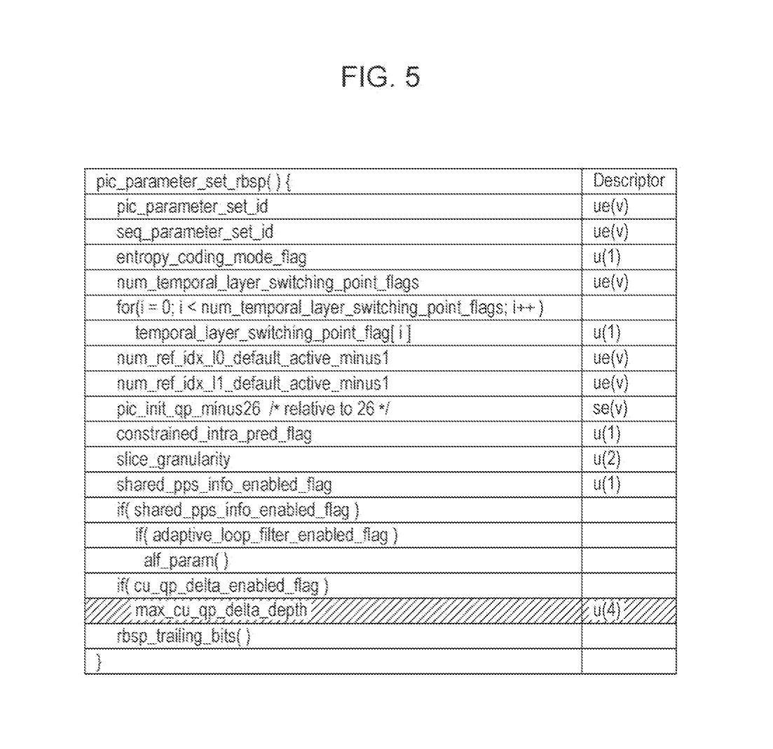

The limit of the size of the CU which can be transmitted is designated by, for example, a max_cu_qp_delta_depth that is a syntax element in the picture parameter set illustrated in FIG. 5.

In addition, in a case of HEVC, in order to decrease the amount of codes, instead of the quantization parameter of the target CU which is subjected to the processing, a difference value (a difference quantization parameter) between the quantization parameter of the target CU and the quantization parameter of the CU in the vicinity of the target CU is transmitted.

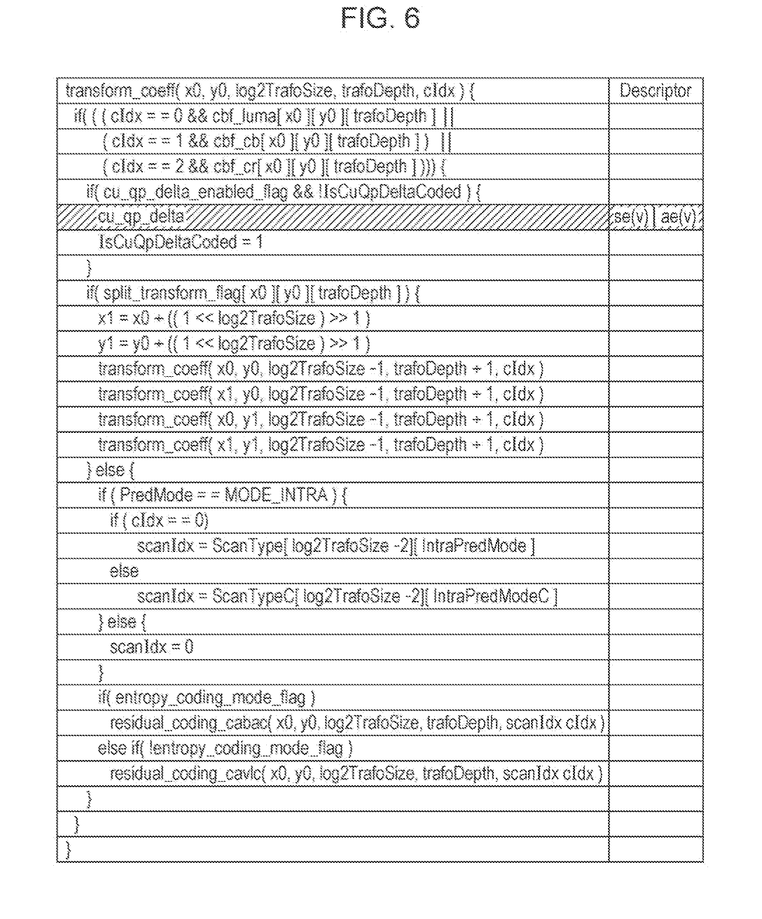

FIG. 6 is a diagram illustrating an example of syntax of a transform coefficient. As illustrated in FIG. 6, for example, a parameter of cu_qp_delta which represents the difference quantization parameter of the target CU is transmitted for each CU having the size equal to or larger than the size designated by the max_cu_qp_delta_depth that is a syntax element described above.

The difference quantization parameter cu_qp_delta is calculated by Formula (3) below.

[Math. 3]

If(left_available)

QP=cu_{—}qp_delta+LeftQP

Else

QP=cu_{—}qp_delta+PrevQP (3)

Here, LeftQP is a quantization parameter of the CU positioned on the left of the target CU, and PrevQP is a quantization parameter of the CU that is processed immediately before the target CU. In other words, the difference value between the quantization parameter of the target CU, and the quantization parameter of the CU positioned on the left of the target CU or the quantization parameter of the CU that is processed immediately before the target CU is transmitted.

### <Control of the Chroma_Qp_Index_Offset>

As described above, the quantization parameter for the color difference signal is generated from the quantization parameter for the brightness signal. Therefore, if the amount of codes is to be decreased, the quantization parameter for the color difference signal is also set to the larger value as the size of the block becomes larger, similar to the quantization parameter for the brightness signal.

However, the block of which the size of the orthogonal transform is large, has little motion, and usually has a uniform image, and thus, frequently it is referred to by the motion vector. For this reason, by setting the quantization parameter for the color difference signal as described above, as the block is more likely to be referred to, the quantization is performed using a larger quantization parameter, and there is a concern of more significantly reducing the quality of the color difference signal.

Therefore, by setting the chroma_qp_index_offset value according to the size of the unit of orthogonal transform by the color difference quantization offset setting unit 121, the quantization is performed by the finer quantization step with respect to the larger sized unit of transform (TU). In other words, the chroma_qp_index_offset of the larger sized unit of transform (TU) is set to a smaller value.

In this way, the color difference quantization offset setting unit 121 can improve the quality of the TU that is more often referred to. In other words, the color difference quantization offset setting unit 121 can suppress the deterioration of the image quality of the color difference signal due to the quantization. In this way, the image coding apparatus 100 can improve the coding efficiency of the output coded data.

### <Orthogonal Transform Unit, Quantization Unit, and Color Difference Quantization Offset Setting Unit>

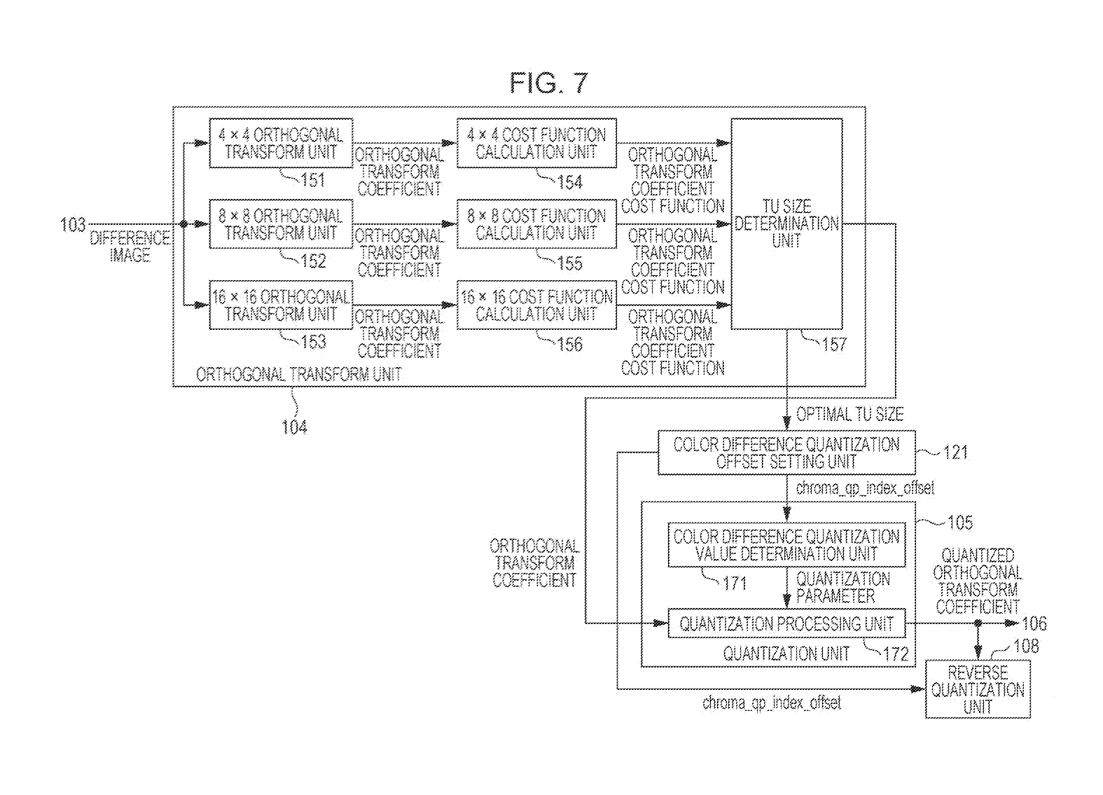

FIG. 7 is a block diagram illustrating configuration examples of the orthogonal transform unit 104 and quantization unit 105 illustrated in FIG. 1.

As illustrated in FIG. 7, the orthogonal transform unit 104 includes a 4×4 orthogonal transform unit 151, an 8×8 orthogonal transform unit 152, a 16×16 orthogonal transform unit 153, a 4×4 cost function calculation unit 154, a 8×8 cost function calculation unit 155, a 16×16 cost function calculation unit 156, and a TU size determination unit 157.

The 4×4 orthogonal transform unit 151 performs the orthogonal transform on the difference image supplied from the calculation unit 103 with 4×4 pixels as the unit of orthogonal transform (TU). The 4×4 orthogonal transform unit 151 supplies the orthogonal transform coefficient obtained as a result of the orthogonal transform to the 4×4 cost function calculation unit 154.

The 4×4 cost function calculation unit 154 calculates a cost function value of a case where the size of the unit of orthogonal transform (TU) is 4×4 pixels using the orthogonal transform coefficient supplied from the 4×4 orthogonal transform unit 151. The 4×4 cost function calculation unit 154 supplies the calculated cost function value to the TU size determination unit 157 together with the orthogonal transform coefficient supplied from the 4×4 orthogonal transform unit 151.

The 8×8 orthogonal transform unit 152 performs the orthogonal transform on the difference image supplied from the calculation unit 103 with 8×8 pixels as the unit of orthogonal transform (TU). The 8×8 orthogonal transform unit 152 supplies the orthogonal transform coefficient obtained as a result of the orthogonal transform to the 8×8 cost function calculation unit 155.

The 8×8 cost function calculation unit 155 calculates a cost function value of a case where the size of the unit of orthogonal transform (TU) is 8×8 pixels using the orthogonal transform coefficient supplied from the 8×8 orthogonal transform unit 152. The 8×8 cost function calculation unit 155 supplies the calculated cost function value to the TU size determination unit 157 together with the orthogonal transform coefficient supplied from the 8×8 orthogonal transform unit 152.

The 16×16 orthogonal transform unit 153 performs the orthogonal transform on the difference image supplied from the calculation unit 103 with 16×16 pixels as the unit of orthogonal transform (TU). The 16×16 orthogonal transform unit 153 supplies the orthogonal transform coefficient obtained as a result of the orthogonal transform to the 16×16 cost function calculation unit 156.

The 16×16 cost function calculation unit 156 calculates a cost function value of a case where the size of the unit of orthogonal transform (TU) is 16×16 pixels using the orthogonal transform coefficient supplied from the 16×16 orthogonal transform unit 153. The 16×16 cost function calculation unit 156 supplies the calculated cost function value to the TU size determination unit 157 together with the orthogonal transform coefficient supplied from the 16×16 orthogonal transform unit 153.

The TU size determination unit 157 compares the cost function values corresponding to the unit of each size of supplied orthogonal transform, and selects the size having the smallest value (the size of which the amount of codes is smallest) as the size (optimal TU size) of the optimal unit of orthogonal transform (TU).

In other words, the orthogonal transform unit 104 performs the orthogonal transform on each candidate of the size of the unit of orthogonal transform prepared in advance, acquires the cost function value, and selects the optimal TU size based on the cost function value.

In a case of FIG. 7, three of 4×4 pixels, 8×8 pixels, and 16×16 pixels are prepared as candidates of the size of the unit of orthogonal transform. However, the number of the candidates and the size of each candidate are optional. For example, a unit of orthogonal transform having a greater size such as 32×32 pixels may be included in the candidate. In addition, for example, a unit of rectangular orthogonal transform such as 4×8 pixels or 16×8 pixels may be included in the candidate.

In addition, the orthogonal transform unit 104 performs the orthogonal transform on all of the candidates prepared in advance like this, acquires the cost function value, and may select the optimal TU size based on the cost function value. However, according to the situation, the orthogonal transform unit 104 may select a part of the candidate, perform the orthogonal transform on only the part of the candidates, acquire the cost function value, and select the optimal TU size among the cost function values. For example, in a case where a limit is needed in the size of the unit of orthogonal transform in an edge of the screen or in a slice boundary, the orthogonal transform unit 104 may select the candidate having an allowable size among the candidates prepared in advance.

The TU size determination unit 157 supplies the information of the selected optimal TU size to the color difference quantization offset setting unit 121. In addition, the TU size determination unit 157 supplies the orthogonal transform coefficient obtained by the orthogonal transform of the difference image supplied from the calculation unit 103 for each unit of orthogonal transform having the optimal TU size to the quantization unit 105 (a quantization processing unit 172).

The color difference quantization offset setting unit 121 sets the chroma_qp_index_offset according to the optimal TU size supplied from the orthogonal transform unit 104. At this time, the color difference quantization offset setting unit 121 sets the smaller value with respect to the larger TU.

For example, the color difference quantization offset setting unit 121 may correct an initial chroma_qp_index_offset value set in advance according to the optimal TU size. In this case, the initial chroma_qp_index_offset value is set in advance for each predetermined unit, such as, for example, for each profile or level, for each sequence, for each picture, or for each slice. In the coding standard, a predetermined fixed value may be defined as the initial chroma_qp_index_offset value.

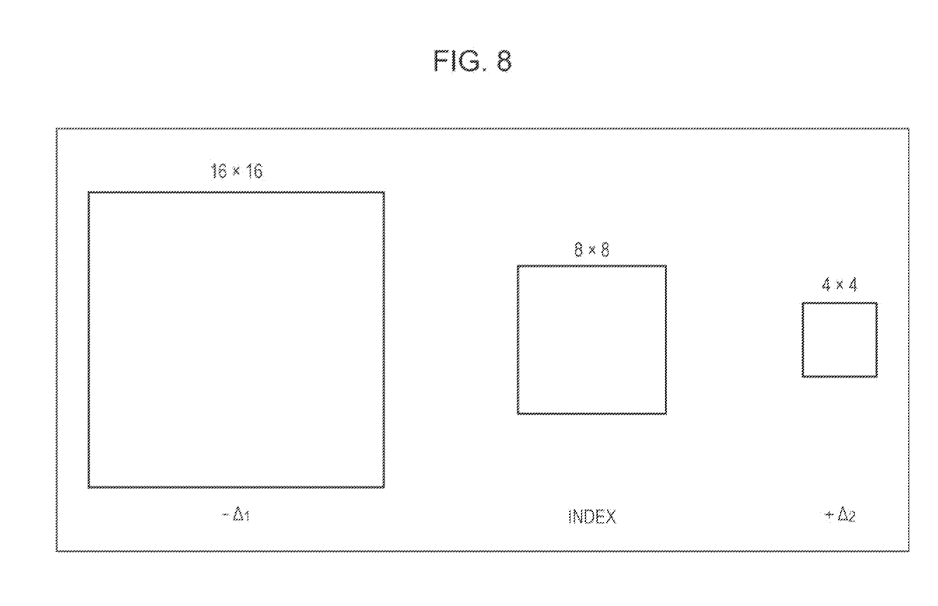

The color difference quantization offset setting unit 121 determines an amount of correction of the chroma_qp_index_offset according to the optimal TU size. For example, as illustrated in FIG. 8, color difference quantization offset setting unit 121 determines the amount of correction as −Δ₁ (Δ₁≧0), 0, and Δ₂ (Δ₂≧0) with respect to each candidate of the 16×16 pixels, 8×8 pixels, and 4×4 pixels. The color difference quantization offset setting unit 121 selects the amount correction corresponding to the optimal TU size among the above values, and corrects the initial chroma_qp_index_offset value by the selected amount of correction.

In the above example, the correction for the case of another TU size is performed using the 8×8 pixels as an index (the TU size corresponding to the initial value of chroma_qp_index_offset). However, the TU size for the index is optional. For example, the 4×4 pixels may be used as an index (amount of correction 0) or the 16×16 pixels may be used as an index (amount of correction 0).

In addition, the amount of correction may be set in advance for all the candidate of the TU size, or may be obtained by a predetermined operation for all or a part of the candidate. Any calculation may be used as far as the amount of correction is determined according to (depends on) the TU size. In addition, the calculation in which the amount of correction depends on a parameter other than the TU size may be used. In this way, it is possible to reduce a storage capacity needed for storing the candidates of the amount of correction.

In addition, the color difference quantization offset setting unit 121 may only select the chroma_qp_index_offset corresponding to the optimal TU size among chroma_qp_index_offset that is set in advance with regard to each candidates of the TU size. In this way, the processing of the color difference quantization offset setting unit 121 becomes easy. However, since many of the candidates of chroma_qp_index_offset should be stored, a larger storing area is needed than that in a case of storing the amount of correction.

The color difference quantization offset setting unit 121 may calculate the chroma_qp_index_offset by a predetermined operation according to the optimal TU size. Any operation may be used as far as the chroma_qp_index_offset value is determined according to (depends on) the TU size. In this way, since it is not necessary to store the chroma_qp_index_offset or the amount of correction, it is possible to reduce the required storage capacity.

In other words, the color difference quantization offset setting unit 121 can calculate the chroma_qp_index_offset that corresponds to the optimal TU size by any method.

The color difference quantization offset setting unit 121 supplies the chroma_qp_index_offset calculated as described above to the quantization unit 105 (a color difference quantization value determination unit 171).

As illustrated in FIG. 7, the quantization unit 105 includes the color difference quantization value determination unit 171 and the quantization processing unit 172.

The color difference quantization value determination unit 171 acquires the quantization parameter for the color difference signal from the chroma_qp_index_offset supplied from the color difference quantization offset setting unit 121 or the quantization parameter for the brightness signal using Formula (2) or a table illustrated in FIG. 3. The color difference quantization value determination unit 171 supplies the acquired quantization parameter for the color difference signal to the quantization processing unit 172.

The quantization processing unit 172 quantizes the orthogonal transform coefficient of the brightness signal supplied from the orthogonal transform unit 104 (the TU size determination unit 157) using the quantization parameter for the brightness signal. In addition, the quantization processing unit 172 quantizes the orthogonal transform coefficient of the color difference signal supplied from the orthogonal transform unit 104 (the TU size determination unit 157) using the quantization parameter for the color difference signal supplied from the color difference quantization value determination unit 171.

Since the quantization parameter for the color difference signal is set to the small value with respect to the large TU as described above, the quantization processing unit 172 can perform the quantization so as to suppress the deterioration of the image quality of the color difference signal.

The quantization processing unit 172 supplies the quantized orthogonal transform coefficient in this way to the reversible coding unit 106 and the reverse quantization unit 108.

The color difference quantization offset setting unit 121 supplies the chroma_qp_index_offset to the reverse quantization unit 108. The reverse quantization unit 108 performs the reverse quantization using the chroma_qp_index_offset, and since the processing is similar to that of the reverse quantization unit of the apparatus of the decoding side (for example, the image decoding apparatus 200 in FIG. 11), the description will not be made (the description on the below-described apparatus of the decoding side can be adapted).

The amount correction Δ₁ and Δ₂ illustrated in FIG. 8 may be the same values as each other or may be different values from each other.

For example, in a case of performing a mode determination by a RD optimization using the cost function, the TU size depends upon the bit rate, that is, the value of the quantization parameter. In other words, in the lower bit rate, the 16×16 pixels is more likely to be selected as the optimal TU size, and in the higher bit rate, the 4×4 pixels is more likely to be selected as the optimal TU size.

For this reason, by individually adjusting the value of Δ₁ and Δ₂ according to the quantization parameter, the image coding apparatus 100 can improve the efficiency of coding.

### <Flow of the Coding Processing>

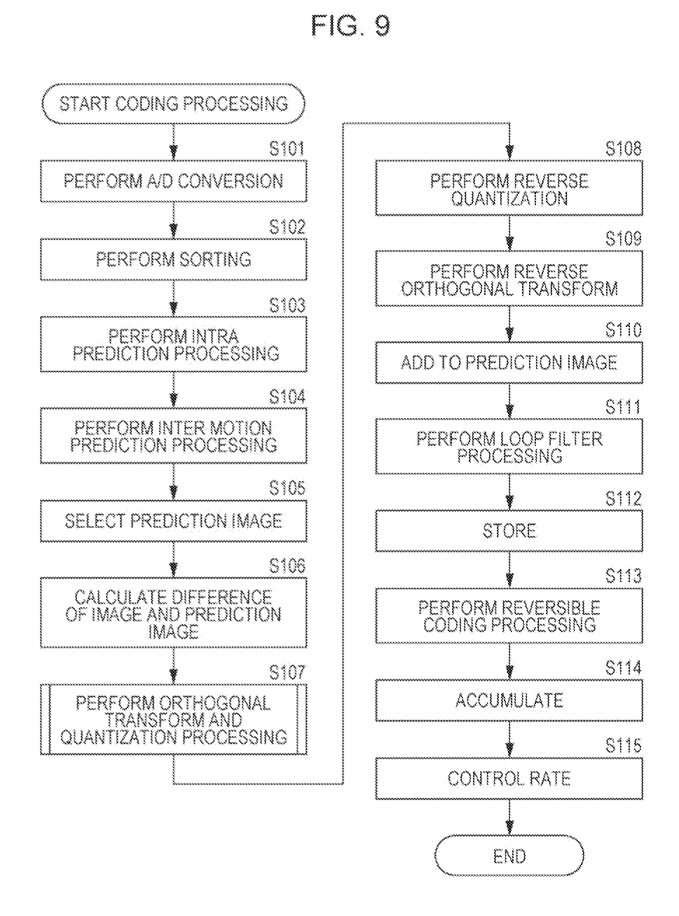

Next, a flow of each of the above processes performed by the image coding apparatus 100 will be described. First, an example of the flow of the coding processing will be described with reference to FIG. 9.

In STEP S101, the A/D conversion unit 101 A/D converts the input image. In STEP S102, the screen sorting buffer 102 stores the A/D converted image, and performs the sorting from the order of displaying each picture to the order of coding.

In STEP S103, the intra prediction unit 114 performs the intra prediction processing of the intra prediction mode. In STEP S104, the motion prediction and compensation unit 115 performs the inter motion prediction processing that performs the motion prediction and motion compensation in the inter prediction mode.

In STEP S105, the prediction image selection unit 116 determines the optimal prediction mode based on each cost function value output from the intra prediction unit 114 and the motion prediction and compensation unit 115. In other words, the prediction image selection unit 116 selects either the prediction image generated by the intra prediction unit 114 or the prediction image generated by the motion prediction and compensation unit 115.

In STEP S106, the calculation unit 103 calculates the difference between the image sorted by the processing in STEP S102 and the prediction image selected by the processing in STEP S105. The amount of data of the difference data is reduced compared to that of the original image data. Therefore, it is possible to compress the data amount compared to the case of coding the image as it is.

In STEP S107, the orthogonal transform unit 104, the quantization unit 105, and the color difference quantization offset setting unit 121 executes the orthogonal transform and quantization processing to perform the orthogonal transform on the difference information generated by the processing in STEP S106 and further to quantize the orthogonal transform.

The difference information quantized by the processing in STEP S107 is locally decoded as follows. In other words, in STEP S108, the reverse quantization unit 108 reverse quantizes the orthogonal transform coefficient quantized by the processing in STEP S107 in a method corresponding to the quantization. In STEP S109, the reverse orthogonal transform unit 109 performs the reverse orthogonal transform on the orthogonal transform coefficient obtained by the processing in STEP S108 in a method corresponding to the processing in STEP S107.

In STEP S110, the calculation unit 110 adds the prediction image to the locally decoded difference information, and generates the locally decoded image (the image corresponding to the input to the calculation unit 103). In STEP S111, the loop filter 111 performs the filtering on the image generated by the processing in STEP S110. In this way, the blocking distortion or the like is removed.

In STEP S112, the frame memory 112 stores the image in which the blocking distortion or the like is removed by the processing in STEP S111. The image in which the filtering processing is not performed by the loop filter 111 is also supplied from the calculation unit 110, and is stored in the frame memory 112.

The image stored in the frame memory 112 is used for the processing in STEP 5103 and STEP S104.

In STEP S113, the reversible coding unit 106 codes the transform coefficient quantized by the processing in STEP S107, and generates the coded data. In other words, a reversible coding such as a variable length coding or an arithmetic coding is performed with respect to the difference image (in a case of inter, a secondary difference image).

The reversible coding unit 106 codes the information related to the prediction mode of the prediction image selected by the processing in STEP S105, and adds the coded information to the coded data obtained by coding the difference image. For example, in a case where the intra prediction mode is selected, the reversible coding unit 106 codes the intra prediction mode information. In addition, for example, in a case where the inter prediction mode is selected, the reversible coding unit 106 codes the inter prediction mode information. The information is added (multiplexed) to the coded data, for example, as header information or the like.

In STEP S114, accumulation buffer 107 accumulates the coded data generated by the processing in STEP S113. The coded data accumulated in the accumulation buffer 107 is appropriately read out and is transmitted to the apparatus of the decoding side via an arbitrary transmission path (not only a communication path but also a recording medium is included).

In STEP S115, the rate control unit 117 controls the rate of the quantization operation of the quantization unit 105 based on the compression image accumulated in the accumulation buffer 107 by the processing in STEP S114 in such a manner that an over flow or an under flow does not occur.

When the processing in STEP S115 ends, the coding processing ends.

### <Flow of the Orthogonal Transform Quantization Processing>

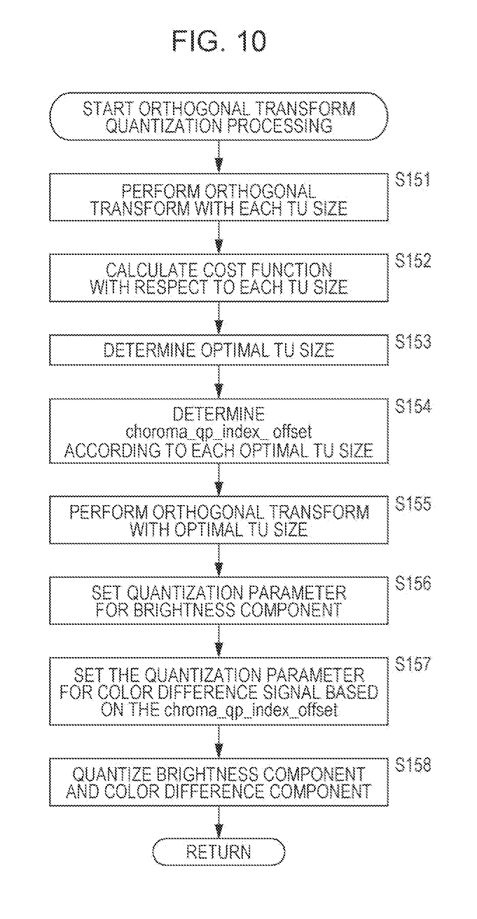

Next, an example of the flow of the orthogonal transform quantization processing performed in STEP S107 in FIG. 9 will be described with reference to a flow chart in FIG. 10.

When the orthogonal transform quantization processing starts, the 4×4 orthogonal transform unit 151, the 8×8 orthogonal transform unit 152, and the 16×16 orthogonal transform unit 153 of the orthogonal transform unit 104 perform the orthogonal transforms with each size as the unit of orthogonal transform (TU) in STEP S151.

In STEP S152, the 4×4 cost function calculation unit 154, the 8×8 cost function calculation unit 155, and the 16×16 cost function calculation unit 156 calculate the cost function with respect to each TU size using the result of the orthogonal transform (orthogonal transform coefficient) of each TU size obtained by the processing in STEP S151.

In STEP S153, the TU size determination unit 157 determines the optimal TU size using the cost function with respect to each TU size calculated in STEP S152.

In STEP S154, the color difference quantization offset setting unit 121 determines the chroma_qp_index_offset according to the optimal TU size determined in STEP S153.

In STEP S155, the orthogonal transform unit 104 performs the orthogonal transform on the difference image with the optimal TU size determined in STEP S153. Here, a new orthogonal transform may be performed. However, for example, the orthogonal transform may be performed in such a manner that the TU size determination unit 157 selects the orthogonal transform coefficient corresponding to the optimal TU size from among the orthogonal transform coefficients corresponding to each TU size obtained in STEP S151.

In STEP S156, the quantization processing unit 172 sets the quantization parameter with respect to the brightness component (brightness signal) of the image subjected to the coding.

In STEP S157, color difference quantization value determination unit 171 sets the quantization parameter with respect to the color difference component (color difference signal) of the image subjected to the coding based on the chroma_qp_index_offset.

In STEP S158, the quantization processing unit 172 quantizes the orthogonal transform coefficient of the brightness signal using the quantization parameter for the brightness signal set in STEP S156. In addition, the quantization processing unit 172 quantizes the orthogonal transform coefficient of the color difference signal using the quantization parameter for the color difference signal set in STEP S157.

In this way, when the brightness component and the color difference component are quantized, the quantization unit 105 ends the orthogonal transform quantization processing, causes the processing to return to STEP S107 in FIG. 9, and repeats the processing thereafter.

As described above, by performing each processing, the image coding apparatus 100 can suppress the deterioration of the image quality of the color difference signal due to the quantization. In this way, the image coding apparatus 100 can improve the coding efficiency of the output coded data.

### 2. Second Embodiment

### Image Decoding Apparatus

FIG. 11 is a block diagram illustrating an example of a main configuration of an image decoding apparatus that is an image processing apparatus to which the present technology is applied. Corresponding to the image coding apparatus 100 described above, the image decoding apparatus 200 illustrated in FIG. 11 correctly decodes the bit stream (coded data) generated by the coding of the image data by the image coding apparatus 100, and generates a decoded image.

As illustrated in FIG. 11, the image decoding apparatus 200 includes an accumulation buffer 201, a reversible decoding unit 202, a reverse quantization unit 203, a reverse orthogonal transform unit 204, a calculation unit 205, a loop filter 206, a screen sorting buffer 207, and a D/A conversion unit 208. In addition, the image decoding apparatus 200 includes a frame memory 209, a selection unit 210, an intra prediction unit 211, a motion prediction and compensation unit 212, and a selection unit 213.

The accumulation buffer 201 accumulates the transmitted coded data and supplies the coded data to the reversible decoding unit 202 at a predetermined timing. The reversible decoding unit 202 decodes the information coded by the reversible coding unit 106 in FIG. 1 and supplied from the accumulation buffer 201 in a method corresponding to coding method of the reversible coding unit 106. The reversible decoding unit 202 supplies the quantized coefficient data of the difference image obtained by decoding to the reverse quantization unit 203.

In addition, the reversible decoding unit 202 determines whether the intra prediction mode or the inter prediction mode is selected as the optimal prediction mode with reference to the information related to the optimal prediction mode obtained by decoding the coded data. In other words, the reversible decoding unit 202 determines whether the prediction mode adopted in the transmitted coded data is the intra prediction mode or the inter prediction mode.

The reversible decoding unit 202 supplies the information related to the prediction mode to the intra prediction unit 211 or the motion prediction and compensation unit 212 based on the determination result. For example, in a case where the intra prediction mode is selected as the optimal prediction mode in the image coding apparatus 100, the reversible decoding unit 202 supplies the intra prediction information that is the information related to the selected intra prediction mode and supplied from the coding side to the intra prediction unit 211. In addition, for example, in a case where the inter prediction mode is selected as the optimal prediction mode in the image coding apparatus 100, the reversible decoding unit 202 supplies the inter prediction information that is the information related to the selected inter prediction mode and supplied from the coding side to the motion prediction and compensation unit 212.

The reverse quantization unit 203 performs the reverse quantization on the quantized coefficient data obtained by coding by the reversible decoding unit 202 in a method (a method similar to that of the reverse quantization unit 108) corresponding to the quantization method of the quantization unit 105 in FIG. 1. The reverse quantization unit 203 supplies the reverse quantized coefficient data to the reverse orthogonal transform unit 204.

The reverse orthogonal transform unit 204 performs the reverse orthogonal transform on the coefficient data supplied from the reverse quantization unit 203 in a method corresponding to the method of the orthogonal transform by the orthogonal transform unit 104 in FIG. 1. By the reverse orthogonal transform processing, the reverse orthogonal transform unit 204 obtains a difference image corresponding to the difference image before the orthogonal transform in the image coding apparatus 100.

The difference image obtained by the reverse orthogonal transform is supplied to the calculation unit 205. In addition to the calculation unit 205, the prediction image from the intra prediction unit 211 or the motion prediction and compensation unit 212 is supplied via the selection unit 213.

The calculation unit 205 adds the difference image and the prediction image and obtains a reconstructed image corresponding to the image from which the prediction image is not subtracted in the calculation unit 103 of the image coding apparatus 100. The calculation unit 205 supplies the reconstructed image to the loop filter 206.

The loop filter 206 appropriately performs loop filter processing including a de-blocking filter processing or an adaptive loop filter processing with respect to the supplied reconstructed image, and generates the decoded image. For example, the loop filter 206 removes the blocking distortion by performing the de-blocking filter processing with respect to the reconstructed image. In addition, for example, the loop filter 206 performs the improvement of the image quality by performing the loop filter processing using the Wiener filter with respect to the result of the de-blocking filter processing (the reconstructed image on which the removal of the blocking distortion is performed).

The type of filter processing performed by the loop filter 206 is optional, and the filter processing other than the above-described processing may be performed. In addition, the loop filter 206 may perform the filter processing using the filter coefficient supplied from the image coding apparatus 100 in FIG. 1.

The loop filter 206 supplies the decoded image that is the result of the filter processing to the screen sorting buffer 207 and the frame memory 209. The filter processing by the loop filter 206 may be omitted. In other words, the output of the calculation unit 205 may be stored in the frame memory 209 without being subjected to filter processing. For example, intra prediction unit 211 uses the pixel value of the pixel included in the image as the pixel value of the peripheral pixel.

The screen sorting buffer 207 performs the sorting of the supplied decoded image. In other words, the order of frames sorted for the order of coding by the screen sorting buffer 102 in FIG. 1 is sorted in the original order of displaying. The D/A conversion unit 208 D/A converts the decoded image supplied from the screen sorting buffer 207 and outputs the D/A converted image to a display (not illustrated) to be displayed.

The frame memory 209 stores the supplied reconstructed image or the decoded image. In addition, the frame memory 209 supplies the stored reconstructed image or the decoded image to the intra prediction unit 211 or the motion prediction and compensation unit 212 via the selection unit 210 at a predetermined timing or based on an external requirement such as the intra prediction unit 211 or the motion prediction and compensation unit 212.

The intra prediction unit 211 performs a processing basically similar to that of the intra prediction unit 114 in FIG. 1. However, the intra prediction unit 211 performs the intra prediction only with respect to the region in which the prediction image is generated by the intra prediction at the time of coding.

The motion prediction and compensation unit 212 performs the inter prediction (including the motion prediction and the motion compensation) based on the inter prediction information supplied from the reversible decoding unit 202 and generates the prediction image. The motion prediction and compensation unit 212 performs inter prediction based on the inter prediction information supplied from the reversible decoding unit 202 only with respect to the region in which the inter prediction is performed at the time of coding.

The intra prediction unit 211 and the motion prediction and compensation unit 212 supplies the prediction image generated for each region of the unit of prediction processing to the calculation unit 205 via the selection unit 213.

The selection unit 213 supplies the prediction image supplied from the intra prediction unit 211 or the prediction image supplied from the motion prediction and compensation unit 212 to the calculation unit 205.

The image decoding apparatus 200 further includes a color difference quantization offset setting unit 221.

In the image decoding apparatus 200 as well, a processing basically similar to the processing performed in the image coding apparatus 100 is performed, the chroma_qp_index_offset is set according to the optimal TU size, and the quantization parameter for the color difference signal is performed using the chroma_qp_index_offset. However, in the case of the image decoding apparatus 200, the optimal TU size is the size of a unit (unit of orthogonal transform) of the actually performed orthogonal transform processing, and therefore, the processing for determining the optimal TU size such as the processing performed by the orthogonal transform unit 104 of the image coding apparatus 100 is omitted.

When the reversible decoding unit 202 decodes the coded data, the reversible decoding unit 202 acquires a size of the unit of orthogonal transform (optimal TU size) with regard to the composite interest region. The information related to the optimal TU size is optional. For example, the optimal TU size may be stored in the predetermined position of the coded data as the syntax illustrated in FIG. 6, or may be transmitted separately from the coded data. The reversible decoding unit 202 analyzes the data obtained by decoding to extract the information related to the optimal TU size, and supplies the information to the color difference quantization offset setting unit 221.

The color difference quantization offset setting unit 221 sets the chroma_qp_index_offset using the optimal TU size supplied from the reversible decoding unit 202. This processing is similar to that in the case of the color difference quantization offset setting unit 121. In other words, the color difference quantization offset setting unit 221 sets the chroma_qp_index_offset in such a manner that the smaller value is set with respect to the larger TU size.

The method of obtaining the chroma_qp_index_offset from the optimal TU size is optional. However, in order to decrease an error of the chroma_qp_index_offset, it is desirable to use the method similar to that of the color difference quantization offset setting unit 121.

To this end, for example, a common method of obtaining the chroma_qp_index_offset may be determined in advance in both the image coding apparatus 100 and the image decoding apparatus 200, or the information related to the method of obtaining the chroma_qp_index_offset adapted in the image coding apparatus 100 may be transmitted to the image decoding apparatus 200 from the image coding apparatus 100.

The color difference quantization offset setting unit 221 supplies the set chroma_qp_index_offset to the reverse quantization unit 203.

The reverse quantization unit 203, regarding the color difference signal, obtains the quantization parameter for the color difference signal using the chroma_qp_index_offset supplied from the color difference quantization offset setting unit 221, and reverse quantizes the orthogonal transform coefficient of the quantized color difference signal supplied from the reversible decoding unit 202.

### <Reversible Decoding Unit, Color Difference Quantization Offset Setting Unit, and Reverse Quantization Unit>

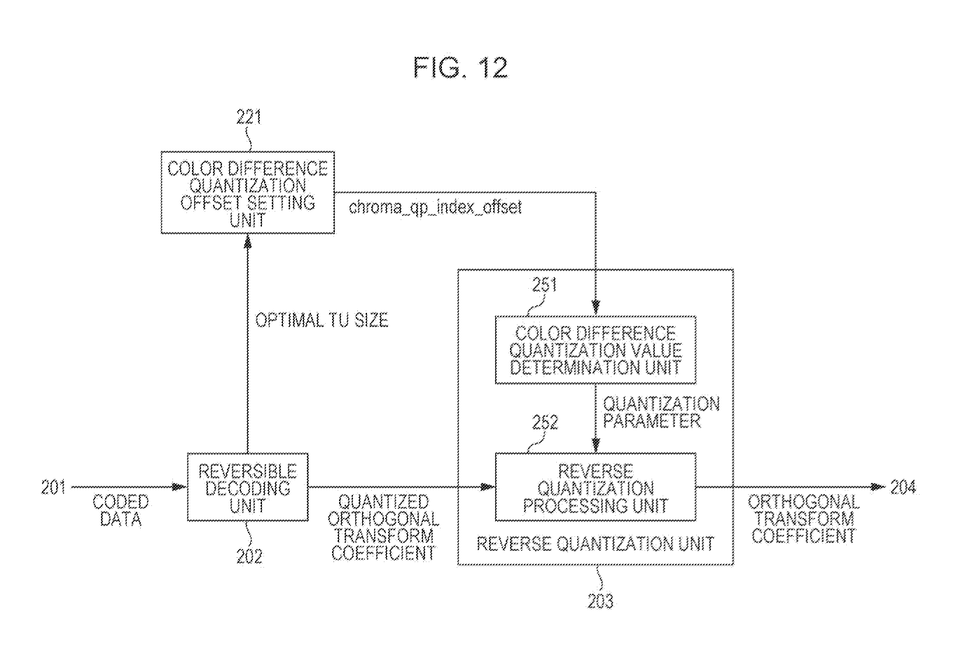

FIG. 12 is a block diagram illustrating an example of a main configuration of the reverse quantization unit 203 in FIG. 11.

As illustrated in FIG. 12, the reverse quantization unit 203 includes a color difference quantization value determination unit 251 and a reverse quantization processing unit 252.

Similar to the color difference quantization value determination unit 171, the color difference quantization value determination unit 251 obtains the quantization parameter for the color difference signal from the chroma_qp_index_offset supplied from the color difference quantization offset setting unit 221 or from the quantization parameter for the brightness signal using above-described Formula (2) or the table illustrated in FIG. 3. The color difference quantization value determination unit 251 supplies the obtained quantization parameter for the color difference signal to the reverse quantization processing unit 252.

The reverse quantization processing unit 252 reverse quantizes the quantized orthogonal transform coefficient of the brightness signal supplied from the reversible decoding unit 202 using the quantization parameter for the brightness signal. In addition, the reverse quantization processing unit 252 reverse quantizes the quantized orthogonal transform coefficient of the color difference signal supplied from the reversible decoding unit 202 using the quantization parameter for the color difference signal supplied from the color difference quantization value determination unit 251.

The reverse quantization processing unit 252 supplies the orthogonal transform coefficient obtained by the reverse quantization to the reverse orthogonal transform unit 204. The reverse orthogonal transform unit 204 performs the reverse orthogonal transform on the orthogonal transform coefficient, and restores the difference image.

In this way, similar to the case of the image coding apparatus 100, the chroma_qp_index_offset value is determined in such a manner that, according to the TU size, the smaller value is set with respect to the larger TU size. Therefore, the reverse quantization unit 203 can correctly reverse quantize the quantized orthogonal transform coefficient in such a manner that the deterioration of the image quality of the color difference signal can be suppressed.

In other words, the image decoding apparatus 200 can correctly decode the coded data obtained by the coding of the image data in such a manner that the deterioration of the image quality of the color difference signal due to the quantization can be suppressed. Therefore, the image decoding apparatus 200 can realize the suppression of the deterioration of the image quality of the color difference signal due to the quantization, and can realize the improvement of the coding efficiency of the coded data.

### <Flow of a Decoding Processing>

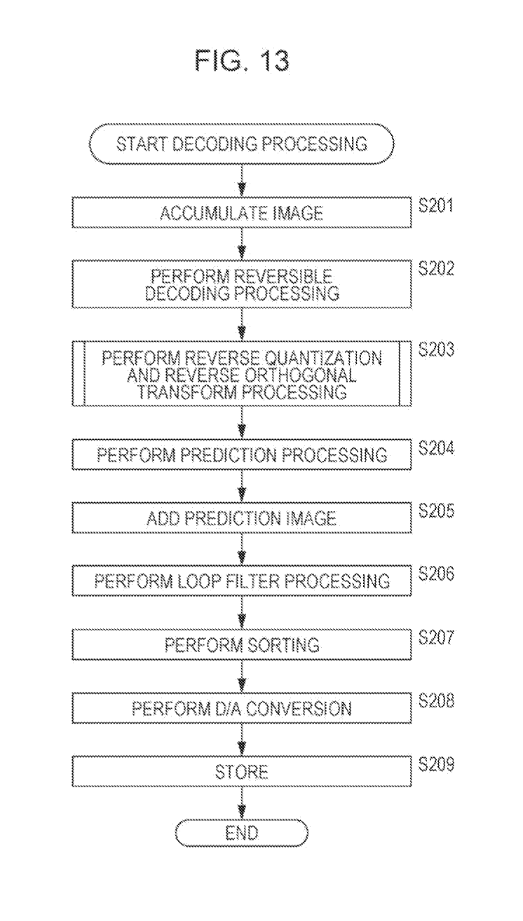

Next, the flow of each processing by the image decoding apparatus 200 described above will be described. First, an example of the flow of a decoding processing will be described with reference to a flow chart in FIG. 13.

When the decoding processing starts, in STEP S201, the accumulation buffer 201 accumulates the transmitted coded data. In STEP S202, the reversible decoding unit 202 decodes the coded data supplied from the accumulation buffer 201. In other words, an I picture, a P picture, and a B picture coded by the reversible coding unit 106 in FIG. 1 are decoded.

At this time, the motion vector information, the reference frame information, the prediction mode information (the intra prediction mode or the inter prediction mode), and information such as the parameter related to the quantization are also decoded.

In STEP S203, the color difference quantization offset setting unit 221, the reverse quantization unit 203, and the reverse orthogonal transform unit 204 perform a reverse quantization and a reverse orthogonal transform processing to reverse quantize the quantized orthogonal transform coefficient obtained by the processing in STEP S202 and to further perform reverse orthogonal transform on the obtained orthogonal transform coefficient.

In this way, the difference information corresponding to the input to the orthogonal transform unit 104 (the output of the calculation unit 103) in FIG. 1 is decoded.

In STEP S204, the intra prediction unit 211 or the motion prediction and compensation unit 212 performs the prediction processing of each image in response to the prediction mode information supplied from the reversible decoding unit 202. In other words, in a case where the intra prediction mode information is supplied from the reversible decoding unit 202, the intra prediction unit 211 performs the intra prediction processing of the intra prediction mode. In addition, in a case where the inter prediction mode information is supplied from the reversible decoding unit 202, the motion prediction and compensation unit 212 performs the inter prediction processing (including the motion prediction and the motion compensation).

In STEP S205, the calculation unit 205 adds the prediction image obtained by the processing in STEP S204 to the difference information obtained by the processing in STEP S203. In this way, the original image data is decoded.

In STEP S206, the loop filter 206 appropriately performs the loop filter processing including the de-blocking filter processing or the adaptive loop filter processing with respect to the reconstructed image obtained by the processing in STEP S205.

In STEP S207, the screen sorting buffer 207 performs the sorting of the frame of the decoded image data. In other words, the order of frames of the decoded image data that is sorted for coding by the screen sorting buffer 102 (FIG. 1) of the image coding apparatus 100 is sorted in the original order of displaying.

In STEP S208, the D/A conversion unit 208 D/A converts the decoded image data of which the frame is sorted by the screen sorting buffer 207. The decoded image data is output to the display (not illustrated), and then the image is displayed.

In STEP S209, the frame memory 209 stores the coded image filtered by the processing in STEP S206.

### <Flow of the Quantization Parameter Decoding Processing>

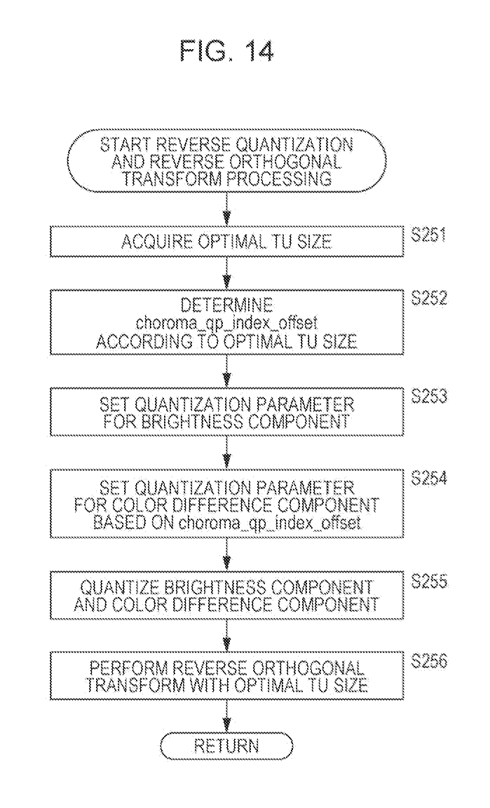

An example of the flow of the reverse quantization and the reverse orthogonal transform processing performed in STEP S203 in FIG. 13 will be described with reference to a flow chart in FIG. 14.

When the reverse quantization and the reverse orthogonal transform processing start, in STEP S251, the color difference quantization offset setting unit 221 acquires the optimal TU size (the TU size of the coded data which is decoded by the reversible decoding unit 202) extracted by the reversible decoding unit 202.

In STEP S252, color difference quantization offset setting unit 221 determines the chroma_qp_index_offset according to the optimal TU size acquired in STEP S251 in such a manner that the smaller value is set with respect to the larger TU size.

In STEP S253, the reverse quantization processing unit 252 sets the quantization parameter with respect to the brightness component of the image (brightness signal).

In STEP S254, color difference quantization value determination unit 251 sets the quantization parameter with respect to the color difference component of the image (color difference signal) based on the chroma_qp_index_offset determined in STEP S252.

In STEP S255, reverse quantization processing unit 252 reverse quantizes the quantized orthogonal transform coefficient of the brightness signal using the quantization parameter with respect to the brightness component set in STEP S253 and using the quantization parameter for the brightness signal. The reverse quantization processing unit 252 quantizes the quantized orthogonal transform coefficient of the color difference signal using the quantization parameter for the color difference signal set in STEP S254.

In STEP S256, the reverse orthogonal transform unit 204 performs the reverse orthogonal transform with respect to the orthogonal transform coefficient obtained by the processing in STEP S255 with the optimal TU size. In this way, when the difference image is restored, the reverse orthogonal transform unit 204 ends the reverse quantization and the reverse orthogonal transform processing, returns the processing to STEP S203 in FIG. 13, and causes the processing thereafter to be executed.

As described above, by performing each processing, the image decoding apparatus 200 can realize the suppression of the deterioration of the image quality of the color difference signal due to the quantization. As a result, the image decoding apparatus 200 can realize the improvement of the coding efficiency of the coded data.

### APPLICATION EXAMPLE

The above descriptions described as the chroma_qp_index_offset are obtained in the image coding apparatus 100 and the image decoding apparatus 200, respectively, but not limited thereto. For example, an apparatus of the coding side (the image coding apparatus 100) may transmit a chroma_qp_index_offset set by itself to an apparatus of the decoding side (the image decoding apparatus 200), and the apparatus of the decoding side (the image decoding apparatus 200) may also obtain a quantization parameter for the color difference signal using the chroma_qp_index_offset.

In this case, the chroma_qp_index_offset may be transmitted by being added to the coded data. In this case, the position where the chroma_qp_index_offset is added is optional.

For example, the chroma_qp_index_offset may be transmitted as a predetermined parameter set. In this case, chroma_qp_index_offset may be transmitted in a single unit for each predetermined unit. For example, the chroma_qp_index_offset in the sequence may be stored in a sequence parameter set (SPS). In addition, the chroma_qp_index_offset in the picture may also be stored in a picture parameter set (PPS). The chroma_qp_index_offset may also be stored in an adaptation parameter set (APS).

The chroma qp_index_offset in the slice may also be stored in a slice header or a CU header. In addition, the chroma_qp_index_offset may also be added to the position other than these positions. Further, information related to one chroma_qp_index_offset may be added to a plurality of positions of the coded data.

Of course, the chroma_qp_index_offset may be transmitted as data other than the coded data.

In addition, instead of the chroma_qp_index_offset, the amount of correction of the chroma_qp_index_offset described above, or various parameters used in determining the chroma_qp_index_offset of each unit of orthogonal transform (UT) such as the candidate of the chroma_qp_index_offset may be transmitted to the apparatus of the decoding side from the apparatus of the coding side. In this case also, the way of transmission is similar to that of the chroma_qp_index_offset described above.

In addition, in the HEVC, a rectangular unit of orthogonal transform (NSQT) such as 32×2 can also be used. A chroma_qp_index_offset value of the rectangular unit of orthogonal transform (TU) having a same (or a similar) area may be used as a chroma_qp_index_offset value of the rectangular unit of orthogonal transform (TU) like this. For example, the chroma_qp_index_offset value of the unit of orthogonal transform (TU) of 32×2 pixels may be set to the same value as that of the unit of orthogonal transform (TU) of 8×8 pixels.

Of course, a new chroma_qp_index_offset value with respect to the rectangular unit of orthogonal transform (TU) may be determined. In other words, the chroma_qp_index_offset may be set according to the size or shape of the unit of orthogonal transform (TU). In addition, the chroma_qp_index_offset may be set according to the size or shape of the unit of orthogonal transform (TU).

In the description, the unit of setting the chroma_qp_index_offset is the unit of orthogonal transform. However, as far as the chroma_qp_index_offset value is for each partial area (local in the picture) in the image (as far as a sub-picture level), the value can be controlled for each optional unit. For example, the unit may be a PU, a CU, or an LCU, or may be a PU. In addition, the unit may be a macro block or a sub-macro block.

### 3. Third Embodiment

### Application to a Multi-Viewpoint Image Coding and a Multi-Viewpoint Image Decoding

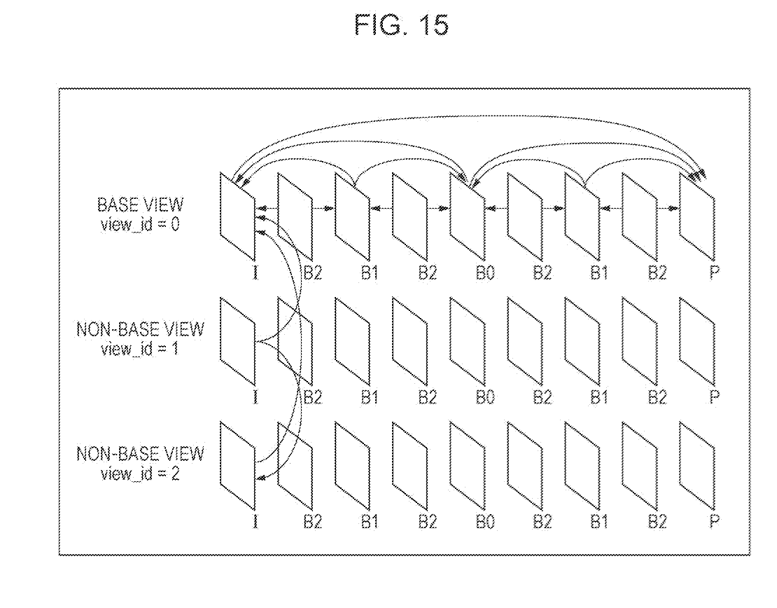

The series of processes described above can be applied to a multi-viewpoint image coding and a multi-viewpoint image decoding. FIG. 15 illustrates an example of a method of multi-viewpoint image coding.

As illustrated in FIG. 15, a multi-viewpoint image includes images having a plurality of view points, and an image of one predetermined view point among the plurality of view points is designated as an image of a base view. An image of each view point other than the image of a base view is treated as a non-base view image.

In a case of coding and decoding of the multi-viewpoint image as illustrated in FIG. 15, the image of each view is coded and decoded, but the method in the first embodiment and the second embodiment described above may be applied to the coding and decoding of each view. In this way, with regard to each view, it is possible to suppress the deterioration of the image quality of the color difference signal due to the quantization.

Furthermore, in the coding and decoding of each view, the flags or parameters used in the method in the first embodiment and the second embodiment described above may be shared. For example, the chroma_qp_index_offset, the optimal TU size, and the quantization parameter for the color difference signal may be shared in the coding and decoding of each view. Of course, only a part thereof may be shared in the coding and decoding of each view, or necessary information other than this may be shared in the coding and decoding of each view. In this way, an increase in the amount of transmitted codes can be suppressed, and the deterioration of the coding efficiency can be suppressed.

The method of sharing is optional. For example, such parameters may be stored in a predetermined referable position in the bit stream processing of each view as parameters common to each view, or the parameters of another view can be referred to in the processing of each view.

### <Multi-Viewpoint Image Coding Apparatus>

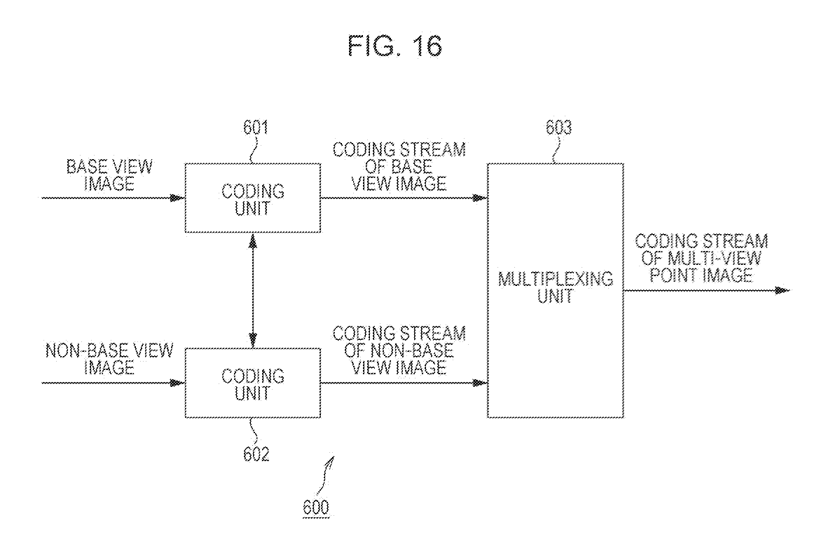

FIG. 16 is a diagram illustrating a multi-viewpoint image coding apparatus that performs the multi-viewpoint image coding described above. As illustrated in FIG. 16, the multi-viewpoint image coding apparatus 600 includes a coding unit 601, a coding unit 602, and a multiplexing unit 603.

The coding unit 601 codes the base view image and generates a base view image coding stream. The coding unit 602 codes the non-base view image and generates a non-base view image coding stream. The multiplexing unit 603 multiplexes the base view image coding stream generated in the coding unit 601 and the non-base view image coding stream generated in the coding unit 602, and generates a multi-viewpoint image coding stream.

The image coding apparatus 100 (FIG. 1) can be applied to the coding unit 601 and the coding unit 602 of the multi-viewpoint image coding apparatus 600. In other words, for example, as described above, the coding unit 601 and the coding unit 602 set the offset value (chroma_qp_index_offset) according to the size or the shape of the unit of orthogonal transform, obtain the quantization parameter for the color difference signal using the offset value, and then quantize the color difference signal using the quantization parameter. In this way, the multi-viewpoint image coding apparatus 600 (the coding unit 601 and the coding unit 602) can suppress the deterioration of the image quality of the color difference signal due to the quantization, with regard to each view.

In addition, by various parameters related to the quantization described above being shared by the coding unit 601 and the coding unit 602, it is possible to suppress the increase of the amount of transmitted codes, and to suppress the deterioration of the coding efficiency.

### <Multi-Viewpoint Image Decoding Apparatus>

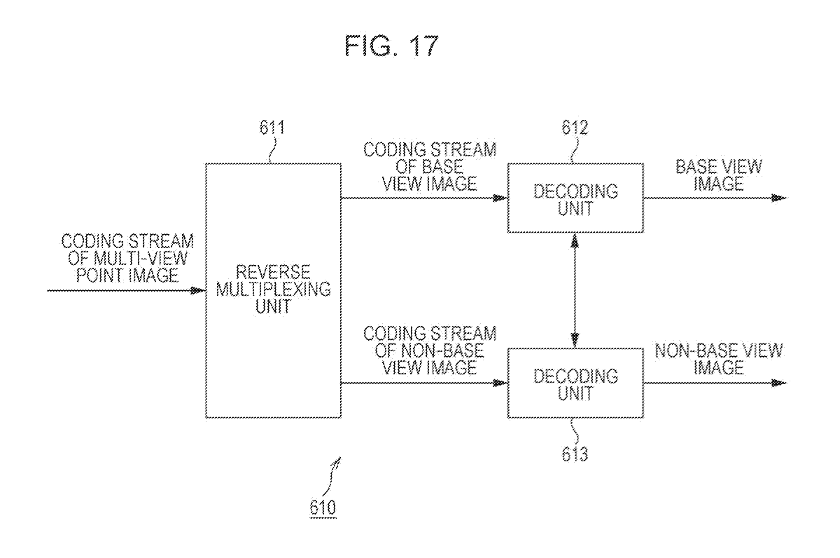

FIG. 17 is a diagram illustrating a multi-viewpoint image decoding apparatus that performs the multi-viewpoint image decoding described above. As illustrated in FIG. 17, the multi-viewpoint image decoding apparatus 610 includes a reverse multiplexing unit 611, a decoding unit 612, and a decoding unit 613.

The reverse multiplexing unit 611 reverse multiplexes the multi-viewpoint image coding stream in which the base view image coding stream and the non-base view image coding stream are multiplexed, and extracts the base view image coding stream and the non-base view image coding stream. The decoding unit 612 decodes the base view image coding stream extracted by the reverse multiplexing unit 611, and obtains the base view image. The decoding unit 613 decodes the non-base view image coding stream extracted by the reverse multiplexing unit 611, and obtains the non-base view image.

The image decoding apparatus 200 (FIG. 11) can be applied to the decoding unit 612 and the decoding unit 613 of the multi-viewpoint image decoding apparatus 610. In other words, for example, as described above, the decoding unit 612 and the decoding unit 613 set the offset value (chroma_qp_index_offset) according to the size or the shape of the unit of orthogonal transform, obtain the quantization parameter for the color difference signal using the offset value, and then quantize the color difference signal using the quantization parameter. In this way, the multi-viewpoint image decoding apparatus 610 (the decoding unit 612 and the decoding unit 613) can correctly reverse quantize the orthogonal transform coefficient quantized such that the deterioration of the image quality of the color difference signal can be suppressed. In other words, the multi-viewpoint image decoding apparatus 610 (the decoding unit 612 and the decoding unit 613) can suppress the deterioration of the image quality of the color difference signal due to the quantization, with regard to each view.

In addition, by various parameters related to the quantization described above being shared by the decoding unit 612 and the decoding unit 613, it is possible to suppress the increase of the amount of transmitted codes, and to suppress the deterioration of the coding efficiency.

### 4. Fourth Embodiment

### Application to a Hierarchical Image Point Coding and a Hierarchical Image Decoding

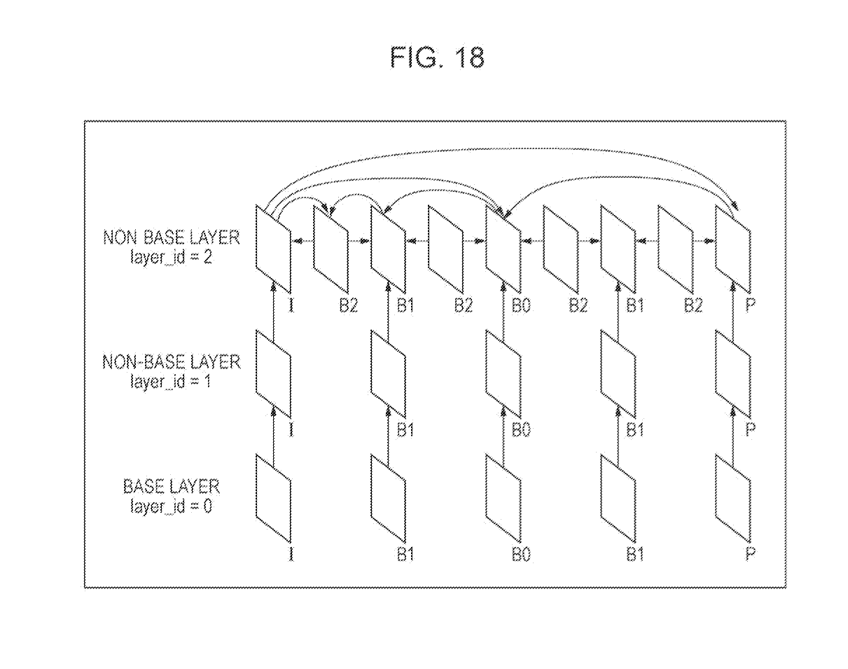

The series of processing described above can be applied to a hierarchical image coding and a hierarchical image decoding. FIG. 18 illustrates an example of a method of a hierarchical image coding.

As illustrated in FIG. 18, a hierarchical image includes an image having a plurality of hierarchies, and an image of one predetermined hierarchy among the plurality of hierarchies is designated as an image of base layer. An image of each hierarchy other than the image of base layer is treated as an image of non-base layer (also referred to as enhancement layer).

In a case of coding and decoding of the hierarchical image as illustrated in FIG. 18, the image of each hierarchy is coded and decoded, but the method in the first embodiment and the second embodiment described above may be applied to the coding and decoding of each hierarchy. In this way, with regard to each hierarchy, it is possible to suppress the deterioration of the image quality of the color difference signal due to the quantization.

Furthermore, in the coding and decoding of each hierarchy, the flags or parameters used in the method in the first embodiment and the second embodiment described above may be shared. For example, the chroma_qp_index_offset, the optimal TU size, and the quantization parameter for the color difference signal may be shared in the coding and decoding of each hierarchy. Of course, only a part thereof may be shared in the coding and decoding of each hierarchy, or necessary information other than this may be shared in the coding and decoding of each hierarchy. In this way, an increase of the amount of codes to be transmitted can be suppressed, and the deterioration of the coding efficiency can be suppressed.

An example of such a hierarchical image includes an image hierarchized by a spatial resolution (referred to as spatial resolution scalability) (spatial scalability). In a case of a hierarchical image having the spatial resolution scalability, the resolution of the image is different for each hierarchy. For example, the hierarchy of the image having the lowest spatial resolution is a base layer, and the hierarchy of the image having the higher spatial resolution than that of the base layer is a non-base layer (enhancement layer).

The image data of the non-base layer (enhancement layer) is data independent from other hierarchies, and similar to the case of the base layer, the image having the resolution in this hierarchy can be obtained only by the image data. However, generally, data corresponding to the difference image of the image of this hierarchy and the image of the other hierarchy (for example, a hierarchy one layer below) is obtained. In this case, the image having a resolution of the hierarchy of the base layer can be obtained only by the image data of the base layer, but the image having a resolution of the hierarchy of the non-base layer (enhancement layer) can be obtained by combining the image data of the hierarchy and the image data of the other hierarchy (for example, the hierarchy one layer below). In this way, it is possible to suppress the redundancy of the image data between the hierarchies.

Since the hierarchical image having the spatial resolution scalability has a different image resolution for each hierarchy, the resolutions of the unit of coding and decoding processing of each hierarchy are different from each other. Therefore, in the coding and decoding of each hierarchy, for example, in a case where the parameters related to the quantization such as the chroma_qp_index_offset, the optimal TU size, and the quantization parameter for the color difference signal are shared, the values of the parameters related to the quantization may be corrected according to the rate of the resolution of each hierarchy.

The parameter to have the scalability is not limited to the spatial resolution, and is, for example, a temporal resolution (temporal scalability). In a case of a hierarchical image having the temporal resolution scalability, the frame rate of the image is different for each hierarchy. In addition, for example, there are the parameters such as a bit-depth scalability in which a bit-depth of the image data is different for each hierarchy, or a chroma scalability in which a component format is different for each hierarchy.

In addition, there is an SNR salability in which a signal to noise ratio (SNR) of the image is different for each hierarchy.

In a case where the parameters have those scalabilities other than the resolution, similar to the case of the resolution, the values of the parameters shared between the hierarchies related to the quantization may be corrected according to the rate of the scalable parameter between the hierarchies.

### <Hierarchical Image Coding Apparatus>

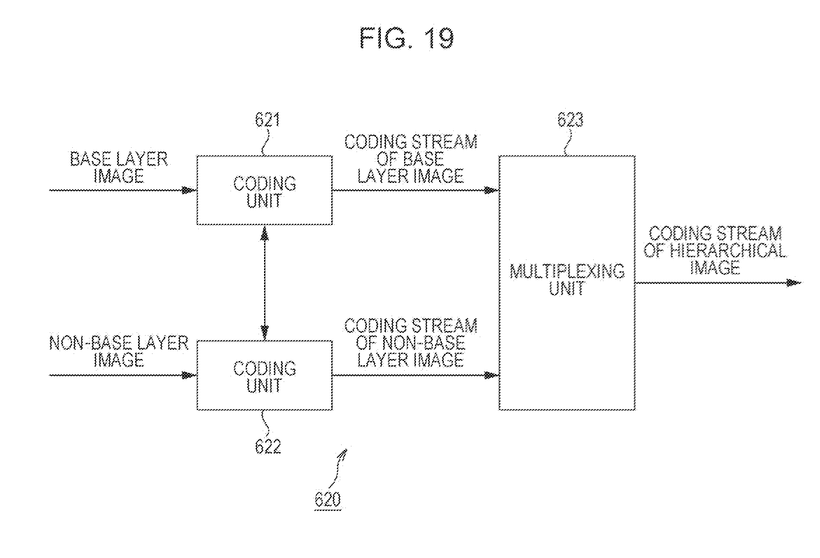

FIG. 19 is a diagram illustrating a hierarchical image coding apparatus that performs the hierarchical image coding described above. As illustrated in FIG. 19, the hierarchical image coding apparatus 620 includes a coding unit 621, a coding unit 622, and a multiplexing unit 623.

The coding unit 621 codes the base layer image, and generates a base layer image coding stream. The coding unit 622 codes the non-base layer image, and generates a non-base layer image coding stream. The multiplexing unit 623 multiplexes the base layer image coding stream generated in the coding unit 621 and the non-base layer image coding stream generated in the coding unit 622, and generates a hierarchical image coding stream.

The image coding apparatus 100 (FIG. 1) can be applied to the coding unit 621 and the coding unit 622 of the hierarchical image coding apparatus 620. In other words, for example, as described above, the coding unit 621 and the coding unit 622 set the offset value (chroma_qp_index_offset) according to the size or the shape of the unit of the orthogonal transform, obtain the quantization parameter for the color difference signal using the offset value, and quantize the color difference signal using the quantization parameter. In this way, the hierarchical image coding apparatus 620 (the coding unit 621 and the coding unit 622) can suppress the deterioration of the image quality of the color difference signal due to the quantization with regard to each hierarchy.

By various parameters related to the quantization described above being shared by the coding unit 621 and the coding unit 622, it is possible to suppress the increase of the amount of transmitted codes, and possible to suppress the deterioration of the coding efficiency.

### <Hierarchical Image Decoding Apparatus>

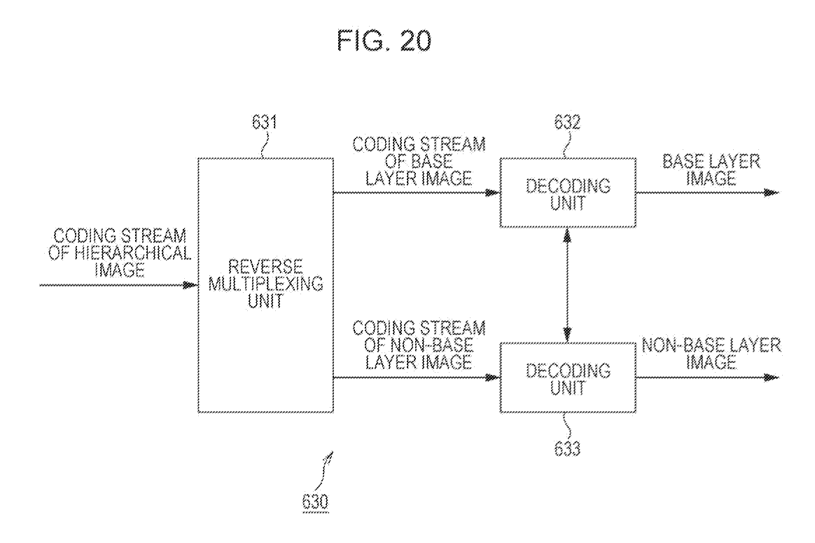

FIG. 20 is a diagram illustrating a hierarchical image decoding apparatus that performs the hierarchical image decoding described above. As described in FIG. 20, the hierarchical image decoding apparatus 630 includes a reverse multiplexing unit 631, a decoding unit 632, and a decoding unit 633.

The reverse multiplexing unit 631 reverse multiplexes the hierarchical image coding stream in which the base layer image coding stream and the non-base layer image coding stream are multiplexed, and extracts the base layer image coding stream and the non-base layer image coding stream. The decoding unit 632 decodes the base layer image coding stream extracted by the reverse multiplexing unit 631 to obtain the base layer image. The decoding unit 633 decodes the non-base layer image coding stream extracted by the reverse multiplexing unit 631 to obtain the non-base layer image.

The image decoding apparatus 200 (FIG. 11) can be applied to the decoding unit 632 and the decoding unit 633 of the hierarchical image decoding apparatus 630. In other words, for example, as described above, the decoding unit 632 and the decoding unit 633 set the offset value (chroma_qp_index_offset) according to the size or the shape of the unit of the orthogonal transform, obtain the quantization parameter for the color difference signal using the offset value, and quantize the color difference signal using the quantization parameter. In this way, the hierarchical image decoding apparatus 630 (the decoding unit 632 and the decoding unit 633) can correctly perform the orthogonal transform on the quantized orthogonal transform coefficient so as to suppress the deterioration of the image quality of the color difference signal with regard to each hierarchy. In other words, the hierarchical image decoding apparatus 630 (the decoding unit 632 and the decoding unit 633) can suppress the deterioration of the image quality of the color difference signal due to the quantization with regard to each hierarchy.

In addition, by various parameters related to the quantization described above being shared by the decoding unit 632 and the decoding unit 633, it is possible to suppress the increase of the amount of transmitted codes, and possible to suppress the deterioration of the coding efficiency.

### 5. Fifth Embodiment

### Computer

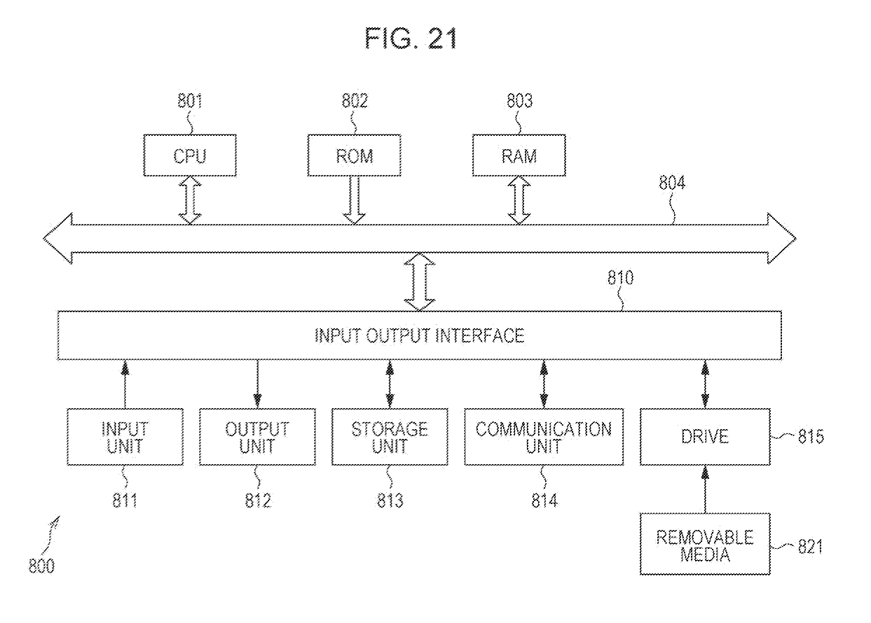

The series of processing described above can be executed by hardware, or can be executed by software. In this case, for example, it may be configured as a computer illustrated in FIG. 21.

In FIG. 21, a central processing unit (CPU) 801 of a computer 800 executes various processing according to a program stored in a read only memory (ROM) 802 or a program loaded from a storage unit 813 to a random access memory (RAM) 803. In the RAM 803, data necessary for the CPU 801 to execute various processing is appropriately stored.

The CPU 801, the ROM 802, and the RAM 803 are connected to each other via a bus 804. An input output interface 810 is also connected to the bus 804.

The following devices are connected to the input output interface 810. Those are: an input unit 811 made of a keyboard, a mouse, a touch panel, and an input terminal; an output unit 812 made of a display made of a cathode ray tube (CRT), a liquid crystal display (LCD), and an organic electroluminescence display (OLED), and an arbitrary output device such as a speaker or an output terminal; a storage unit 813 configured with an arbitrary storage medium such as a hard disk or a flash memory or a control unit that controls the input and output to and from the storage medium; and a communication unit 814 made of an arbitrary wired or a wireless communication device such as a modem, a LAN interface, a universal serial bus (USB) or Bluetooth®. The communication unit 814, for example, performs a communication processing with other communication devices via a network including the Internet.

To the input output interface 810, a drive 815 is connected as necessary. On the drive 815, a removable medium 821 such as a magnetic disk, an optical disc, a magneto optical disk, or a semiconductor memory is appropriately mounted. The drive 815, for example, reads the computer program and the data from the removable media 821 mounted on itself according to the control of the CPU 801. The read data and the computer program are supplied to the RAM 803, for example. The computer program read from the removable media 821 is installed in the storage unit 813 as necessary.

In a case where the series of processing described above are executed by software, the program configuring the software is installed from the network or the recording medium.

The recording medium, for example, as illustrated in FIG. 21, separated from the apparatus main body, is not only configured with the removable media 821 such as the magnetic disc in which the program distributed for delivering the program to the user is recorded (including a flexible disc), the optical disc (including a compact disc read-only memory (CD-ROM)), a digital versatile disc (DVD), the magneto optical disc (including a mini disc (MD)), or the semiconductor memory, but is also configured with the ROM 802 in which the program delivered to the user is recorded in a state where it is incorporated in the apparatus in advance, or a hard disc included in the storage unit 813.

The program executed by the computer may be a program in which the processing is performed in time series in an order of the description in this specification, or may be a program in which the processing is performed in parallel or at the necessary timing such as when the program is read out.

In addition, in the specification, STEP for describing the program recorded in the recording medium includes the processing performed in time series in the order of description, but not necessarily in time series; the processing in parallel or individually executed processing may also be included.

In addition, in the Specification, the system represents the entire system configured with a plurality of devices (apparatuses).

In addition, in the description above, the configuration described as one apparatus (or the processing unit) may be divided, and may be configured with a plurality of apparatuses (or the processing units). In reverse, in the description above, the configuration described as a plurality of apparatuses (or the processing unit) may be combined to be configured in one apparatus (or the processing unit). Of course, configurations other than the above-described may be added to the configuration of each apparatus (or each processing unit). Further, if the configuration or the operation as a whole system are actually the same, a part of the configuration of a certain apparatus (or the processing unit) may be included in the configuration of the other apparatus (or the other processing unit). In other words, the embodiment of the present technology is not limited to the embodiments described above, and various modifications can be made without departing from the spirit of the present technology.

The image coding apparatus 100 (FIG. 1) and the image decoding apparatus 200 (FIG. 11) in the embodiments described above can be applicable to a satellite broadcasting, a cable broadcasting such as a cable TV network, a variety of electronic devices such as a transmitter or a receiver in the distribution on the Internet or distribution to the terminal by a cellular communication, a recording device that records an image in the medium such as an optical disc, magnetic disc and a flash memory, or a reproduction device that reproduces the image from the recording media. Hereinafter, four application examples will be described.

### 6. Sixth Embodiment

### Television Apparatus

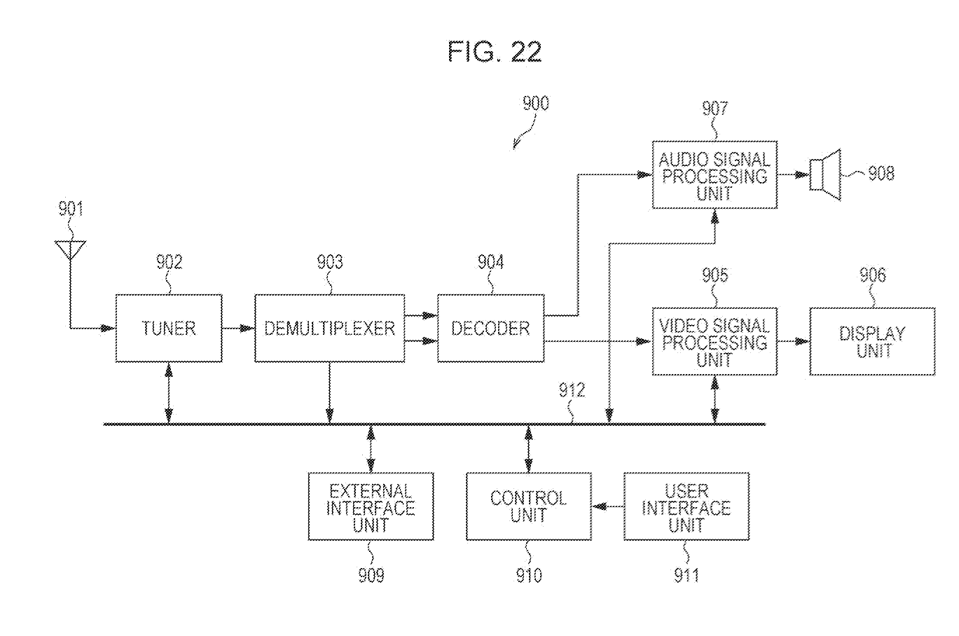

FIG. 22 illustrates an example of a schematic configuration of a television apparatus to which the above-described embodiments are applied. The television apparatus 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a signal of a desired channel from a broadcasting signal received via the antenna 901, and demodulates the extracted signal. Then, the tuner 902 outputs the coded bit stream obtained by the demodulation to the demultiplexer 903. That is, the tuner 902 has a function as a transmission unit in the television apparatus 900 that receives the coding stream in which the image is coded.

The demultiplexer 903 separates a video stream and an audio stream of a program to be watched from the coded bit stream, and outputs each separated stream to the decoder 904. In addition, the demultiplexer 903 extracts auxiliary data such as an electronic program guide (EPG) from the coded bit stream, and supplies the extracted data to the control unit 910. The demultiplexer 903 may perform descrambling in a case where the coded bit stream is scrambled.

The decoder 904 decodes the video stream and the audio stream input from the demultiplexer 903. Then, the decoder 904 outputs the video data generated by the decoding processing to the video signal processing unit 905. In addition, the decoder 904 outputs the audio data generated by the decoding processing to the audio signal processing unit 907.

The video signal processing unit 905 reproduces the video data input from the decoder 904, and causes the display unit 906 to display the video. In addition, the video signal processing unit 905 may cause the display unit 906 to display an application screen supplied via the network. In addition, the video signal processing unit 905 may perform an additional processing such as a removal of a noise with regard to the video data according to a setting. Further, the video signal processing unit 905 may generate an image of a graphical user interface (GUI) such as a menu, a button or a cursor, and may superimpose the generated image on the output image.

The display unit 906 is driven by a drive signal supplied from the video signal processing unit 905, and displays the video or the image on the screen of the display device (for example, a liquid crystal display, a plasma display, or an organic electroluminescence display (OLED)).

The audio signal processing unit 907 performs a reproduction processing such as a D/A conversion and amplification with regard to the audio data input from the decoder 904, and causes the voice to be output from the speaker 908. In addition, the audio signal processing unit 907 may perform an additional processing such as noise removal with regard to the audio data.

The external interface 909 is an interface for connecting the television apparatus 900 to an external apparatus or to a network. For example, the video stream or the audio stream received via the external interface 909 may be decoded by the decoder 904. In other words, the external interface 909 also has a function as a transmission unit in the television apparatus 900 that receives the coding stream in which the image is coded.

The control unit 910 includes a processor such as a CPU and a memory such as a RAM and ROM. The memory stores a program that is executed by the CPU, program data, EPG data, and data acquired via the network. The program stored in the memory, for example, is read by the CPU to be executed at the time when the television apparatus 900 activates. By executing the program, for example, the CPU controls the operation of the television apparatus 900 according to the operation signal input from the user interface 911.

The user interface 911 is connected to the control unit 910. The user interface 911, for example, includes a button and a switch for operating the television apparatus 900 by the user, and a receiving unit for receiving a remote control signal. The user interface 911 detects a user's operation via the configuration elements and generates an operation signal, and then outputs the generated operation signal to the control unit 910.

The bus 912 connects the tuner 902, the demultiplexer 903, the decoder 904, the video signal processing unit 905, the audio signal processing unit 907, external interface 909, and the control unit 910 to each other.

In the television apparatus 900 configured in this way, the decoder 904 has a function of the image decoding apparatus 200 (FIG. 11) in the embodiment described above. Therefore, the decoder 904 can acquire the quantization parameter for the color difference signal using the offset value with respect to the quantization parameter for the brightness signal controlled according to the size of the unit of the processing of the orthogonal transform. Therefore, the television apparatus 900 can realize the suppression of the deterioration of the image quality of the color difference signal due to the quantization.

### 7. Seventh Embodiment

### Mobile Phone

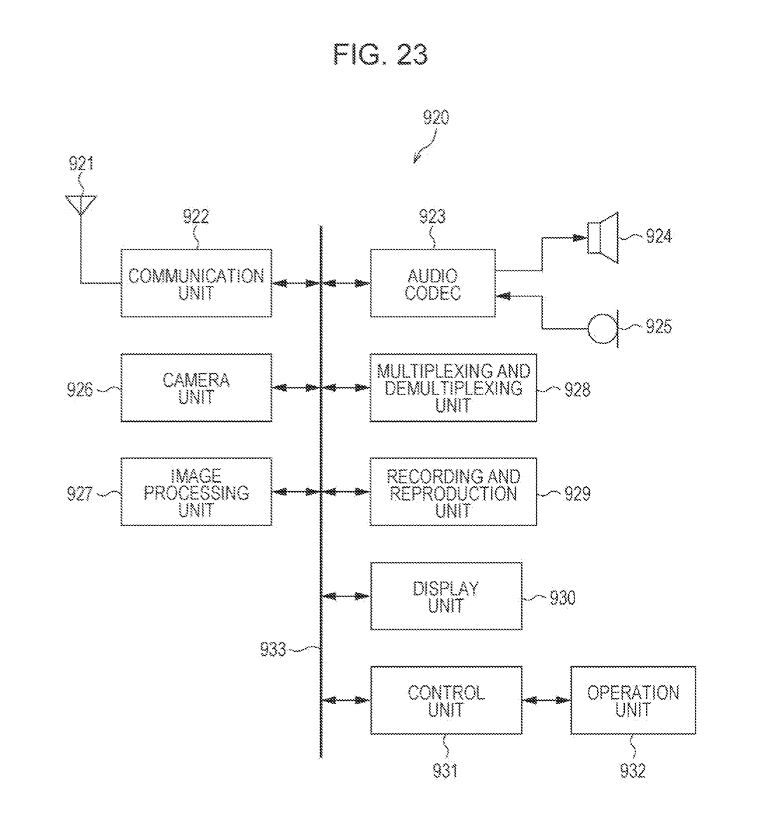

FIG. 23 illustrates an example of a schematic configuration of a mobile phone to which the embodiment described above is applied. A mobile phone 920 includes an antenna 921, a communication unit 922, an audio codec 923, a speaker 924, a microphone 925, a camera unit 926, an image processing unit 927, a multiplexing and demultiplexing unit 928, a recording and reproduction unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 connects the communication unit 922, the audio codec 923, the camera unit 926, the image processing unit 927, the multiplexing and demultiplexing unit 928, the recording and reproduction unit 929, the display unit 930, and the control unit 931 to each other.

The mobile phone 920 performs various operations such as a transmission and reception of an audio signal, a transmission and reception of an electronic mail or image data, an imaging of an image, and a recording of the data in various operation modes such as a voice call mode, a data communication mode, an imaging mode and a TV phone mode.

In the voice call mode, an analog audio signal generated by the microphone 925 is supplied to the audio codec 923. The audio codec 923 converts the analog audio signal to audio data, and A/D converts the converted audio data to be compressed. Then, the audio codec 923 outputs the compressed audio data to the communication unit 922. The communication unit 922 codes and modulates the audio data, and generates a transmission signal. Then, the communication unit 922 transmits the generated transmission signal to the base station (not illustrated) via the antenna 921. In addition, the communication unit 922 amplifies and performs a frequency conversion on the wireless signal transmitted via the antenna 921 to acquire a received signal. Then, the communication unit 922 demodulates and decodes the received signal to generate the audio data, and outputs the generated audio data to the audio codec 923. The audio codec 923 decompresses the audio data and performs the D/A conversion to generate the analog audio signal. Then, the audio codec 923 supplies the generated audio signal to the speaker 924 to output the voice.

In addition, in the data communication mode, for example, the control unit 931 generates character data that configures the electronic mail according to the user's operation via the operation unit 932. In addition, the control unit 931 causes the characters to be displayed on the display unit 930. In addition, the control unit 931 generates electronic mail data and outputs the generated electronic mail data to the communication unit 922 according to the transmission instruction from the user via the operation unit 932. The communication unit 922 codes and modulates the electronic mail data to generate a transmission signal. Then, the communication unit 922 transmits the generated transmission signal to the base station (not illustrated) via the antenna 921. In addition, the communication unit 922 amplifies and performs a frequency conversion on the wireless signal received via the antenna 921 to acquire a received signal. Then, communication unit 922 demodulates and decodes the received signal to restore the electronic mail data, and outputs the restored electronic mail data to the control unit 931. The control unit 931 causes the content of the electronic mail data to be displayed on the display unit 930, and causes the electronic mail to be stored in the storage medium of the recording and reproduction unit 929.

The recording and reproduction unit 929 includes an arbitrary readable and writable storage medium. For example, the storage medium may be an embedded type storage medium such as a RAM or a flash memory, or may be an external mount type storage medium such as a hard disc, a magnetic disc, a magneto optical disc, an optical disc, a USB memory, or a memory card.

In addition, in the imaging mode, for example, the camera unit 926 images a subject and generates image data, and outputs the generated image data to the image processing unit 927. The image processing unit 927 codes the image data input from the camera unit 926, and causes the coding stream to be stored in the storage medium of the recording and reproduction unit 929.

In addition, in the TV phone mode, for example, the multiplexing and demultiplexing unit 928 multiplexes the video stream coded by the image processing unit 927 and the audio stream input from the audio codec 923, and outputs the multiplexed stream to the communication unit 922. The communication unit 922 codes and modulates the stream to generate a transmission signal. Then, the communication unit 922 transmits the generated transmission signal to the base station (not illustrated) via the antenna 921. The communication unit 922 amplifies and performs a frequency conversion on the wireless signal received via the antenna 921 to acquire a received signal. The coded bit stream can be included in the transmission signal and the received signal. Then, the communication unit 922 demodulates and decodes the received signal to restore the stream, and outputs the restored stream to the multiplexing and demultiplexing unit 928. The multiplexing and demultiplexing unit 928 demultiplexes the video stream and the audio stream from the input stream, and outputs the video stream to the image processing unit 927 and the audio stream to the audio codec 923. The image processing unit 927 decodes the video stream and generates the video data. The video data is supplied to the display unit 930, and a series of image is displayed on the display unit 930. The audio codec 923 decompresses the audio stream and performs the D/A conversion to generate the analog audio signal. Then, the audio codec 923 supplies the generated audio signal to the speaker 924 to output the voice.

In the mobile phone 920 configured in this way, the image processing unit 927 has the function of the image coding apparatus 100 (FIG. 1) and the function of the image decoding apparatus 200 (FIG. 11) in the embodiments described above. Therefore, with regard to the image coded and decoded in the mobile phone 920, the image processing unit 927 can control the offset value of the quantization parameter for the color difference signal with respect to the quantization parameter for the brightness signal according to the size of the unit of the processing of the orthogonal transform, and can acquire the quantization parameter for the color difference signal from the quantization parameter for the brightness signal using the offset value. Therefore, the mobile phone 920 can suppress the deterioration of the image quality of the color difference signal due to the quantization.

In addition, the above description is made using a mobile phone 920. However, similar to the case of the mobile phone 920, the image coding apparatus and the image decoding apparatus to which the present technology is applied can be applied to any apparatus that has an imaging function or a communication function similar to the mobile phone 920 such as a personal digital assistant (PDA), a smart phone, an ultra mobile personal computer (UMPC), a netbook, or a notebook type personal computer.

### 8. Eighth Embodiment

### Recording and Reproduction Apparatus

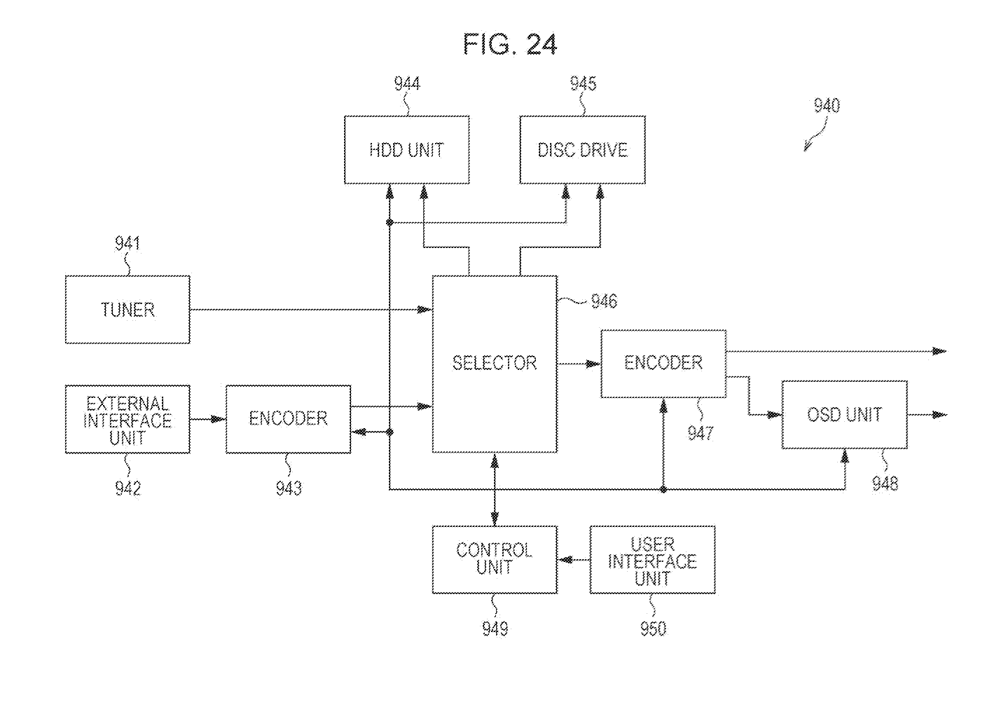

FIG. 24 illustrates an example of a schematic configuration of a recording and reproduction apparatus to which the embodiment described above is applied. In addition, a recording and reproduction apparatus 940, for example, codes audio data and video data of a received broadcasting program and records the data in the recording medium. In addition, the recording and reproduction apparatus 940, for example, may code audio data and video data acquired from another apparatus and record the data in the recording medium. In addition, the recording and reproduction apparatus 940, for example, reproduces the data recorded in the recording medium on a monitor or a speaker according to the user's instruction. At this time, the recording and reproduction apparatus 940 decodes the audio data and the video data.

The recording and reproduction apparatus 940 includes a tuner 941, an external interface 942, an encoder 943, a hard disc drive (HDD) 944, a disc drive 945, a selector 946, a decoder 947, an on-screen display (OSD) 948, a control unit 949, and a user interface 950.

The tuner 941 extracts a signal of a desired channel from a broadcasting signal received via an antenna (not illustrated), and demodulates the extracted signal. Then, the tuner 941 outputs a coded bit stream obtained by the demodulation to the selector 946. That is, the tuner 941 has a function as a transmission unit in the recording and reproduction apparatus 940.

The external interface 942 is an interface for connecting the recording and reproduction apparatus 940 and an external apparatus or a network. The external interface 942, for example, may be an IEEE1394 interface, a network interface, a USB interface, or a flash memory interface. For example, the video data and the audio data received via the external interface 942 are input to the encoder 943. That is, the external interface 942 has a function as a transmission unit in the recording and reproduction apparatus 940.

The encoder 943 codes the video data and the audio data in a case where the video data and the audio data input from the external interface 942 are not coded. Then, the encoder 943 outputs the coded bit stream to the selector 946.

The HDD 944 records the coded bit stream in which the content data such as video and audio content is compressed, various programs, and other data in the internal hard disc. In addition, the HDD 944 reads these data from the hard disc at the time of reproducing the video and voice.

The disc drive 945 performs the recording and reading the data to and from the mounted recording medium. The recording medium mounted on the disc drive 945 may be, for example, a DVD disc (DVD-video, DVD-RAM, DVD-R, DVD-RW, DVD+R, DVD+RW, and the like) or a Blu-ray® disc.

The selector 946 selects the coded bit stream input from the tuner 941 or the encoder 943, and outputs the selected coded bit stream to the HDD 944 or the disc drive 945 when the video and the voice are recorded. In addition, the selector 946 outputs the coded bit stream input from the HDD 944 or the disc drive 945 to the decoder 947 when the video and the voice is reproduced.

The decoder 947 decodes the coded bit stream to generate the video data and the audio data. Then, the decoder 947 outputs the generated video data to the OSD 948. In addition, the decoder 904 outputs the generated audio data to the external speaker.

The OSD 948 reproduces the video data input from the decoder 947 and displays the video. In addition, the OSD 948 may superimpose an image of a GUI such as a menu, a button, or a cursor on the displayed image.

The control unit 949 includes a processor such as a CPU and a memory such as RAM and ROM. The memory stores a program executed by the CPU and program data. The program stored in the memory, for example, is read by the CPU to be executed at the time when the recording and reproduction apparatus 940 activates the operation. By executing the program, the CPU controls the operation of the recording and reproduction apparatus 940 according to an operation signal input from the user interface 950.

The user interface 950 is connected to the control unit 949. The user interface 950 includes, for example, a button and a switch for operating the recording and reproduction apparatus 940, and a receiving unit of a remote control signal. The user interface 950 detects the user's operation via these configuration elements to generate an operation signal, and outputs the generated operation signal to the control unit 949.

In the recording and reproduction apparatus 940 configured in this way, the encoder 943 has a function of the image coding apparatus 100 (FIG. 1) in the embodiment described above. In addition, the decoder 947 has a function of the image decoding apparatus 200 (FIG. 11) in the embodiment described above. Therefore, with regard to the image coded and decoded in the recording and reproduction apparatus 940, the encoder 943 and the decoder 947 can control the offset value of the quantization parameter for the color difference signal with respect to the quantization parameter for the brightness signal according to the size of the unit of the processing of the orthogonal transform, and can acquire the quantization parameter for the color difference signal from the quantization parameter for the brightness signal using the offset value. Therefore, the recording and reproduction apparatus 940 can suppress the deterioration of the image quality of the color difference signal due to the quantization.

### 9. Ninth Embodiment

### Imaging Apparatus

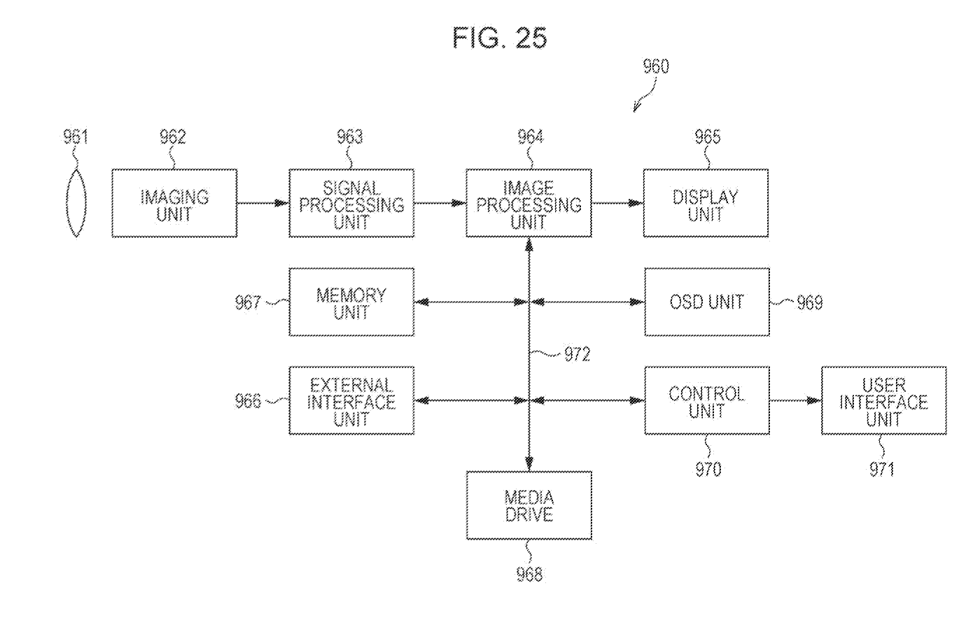

FIG. 25 illustrates an example of a schematic configuration of an imaging apparatus to which the embodiment described above is applied. An imaging apparatus 960 images a subject and generates an image, codes the image data, and records the coded image data in a recording medium.

The imaging apparatus 960 includes an optical block 961, an imaging unit 962, a signal processing unit 963, an image processing unit 964, a display unit 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 connects the image processing unit 964, the external interface 966, the memory 967, the media drive 968, OSD 969, and the control unit 970 to each other.

The optical block 961 includes a focus lens, an aperture mechanism, and the like. The optical block 961 forms an optical image of a subject on the imaging surface of the imaging unit 962. The imaging unit 962 includes an image sensor such as a CCD or a CMOS, and converts the optical image formed on the imaging surface to an image signal as an electric signal by a photoelectric conversion. Then, the imaging unit 962 outputs the image signal to the signal processing unit 963.

The signal processing unit 963 performs various camera signal processes such as a knee correction, a gamma correction, and a color correction with respect to the image signal input from the imaging unit 962. The signal processing unit 963 outputs the image data after the camera signal processing to the image processing unit 964.

The image processing unit 964 codes the image data input from the signal processing unit 963, and generates a coded data. Then, the image processing unit 964 outputs the generated coded data to the external interface 966 or the media drive 968. In addition, the image processing unit 964 decodes the coded data input from the external interface 966 or the media drive 968 to generate the image data. Then, the image processing unit 964 outputs the generated image data to the display unit 965. In addition, the image processing unit 964 may output the image data input from the signal processing unit 963 to the display unit 965 to display the image. In addition, the image processing unit 964 may superimpose the display data acquired from the OSD 969 to the image output to the display unit 965.

The OSD 969, for example, generates an image of a GUI such as a menu, a button or a cursor, and outputs the generated image to the image processing unit 964.

The external interface 966 is configured, for example, as a USB input and output terminal. The external interface 966, for example, connects the imaging apparatus 960 and a printer when the image is printed. In addition, a drive is connected to the external interface 966 as needed. For example, a removable medium such as a magnetic disc or an optical disc is mounted on the drive, and a program read from the removable media can be installed in the imaging apparatus 960. Further, the external interface 966 may be configured as a network interface which is connected to a network such as a LAN or the Internet. In other words, the external interface 966 has a function as a transmission unit in the imaging apparatus 960.

A recording medium mounted on the media drive 968, for example, may be an arbitrary readable removable medium such as a magnetic disc, a magneto optical disc, an optical disc or a semiconductor memory. In addition, the recording medium may be fixedly mounted on the media drive 968. For example, the media drive 968 may be configured to include a non-transportable storage unit such as an embedded type hard disc drive or a solid state drive (SSD).

The control unit 970 includes a processor such as a CPU and a memory such as RAM and ROM. The memory stores a program executed by the CPU and program data. The program stored in the memory, for example, is read by the CPU to be executed at the time when the imaging apparatus 960 activates. By executing the program, the CPU controls the operation of the imaging apparatus 960 according to an operation signal input from the user interface 971.

The user interface 971 is connected to the control unit 970. The user interface 971 includes, for example, a button and a switch for operating the imaging apparatus 960. The user interface 971 detects the user's operation via these configuration elements to generate an operation signal, and outputs the generated operation signal to the control unit 970.

In the imaging apparatus 960 configured in this way, the image processing unit 964 has a function of the image coding apparatus 100 (FIG. 1) and a function of the image decoding apparatus 200 (FIG. 11) in the embodiments described above. Therefore, with regard to the image coded and decoded in the imaging apparatus 960, the image processing unit 964 can control the offset value of the quantization parameter for the color difference signal with respect to the quantization parameter for the brightness signal according to the size of the unit of the processing of the orthogonal transform, and can acquire the quantization parameter for the color difference signal from the quantization parameter for the brightness signal using the offset value. Therefore, the imaging apparatus 960 can suppress the deterioration of the image quality of the color difference signal due to the quantization.

Of course, the image coding apparatus and the image decoding apparatus to which the present technology is applied are also applicable to an apparatus or a system other than the apparatuses described above.

### 10. Application Example of a Scalable Coding

### First System

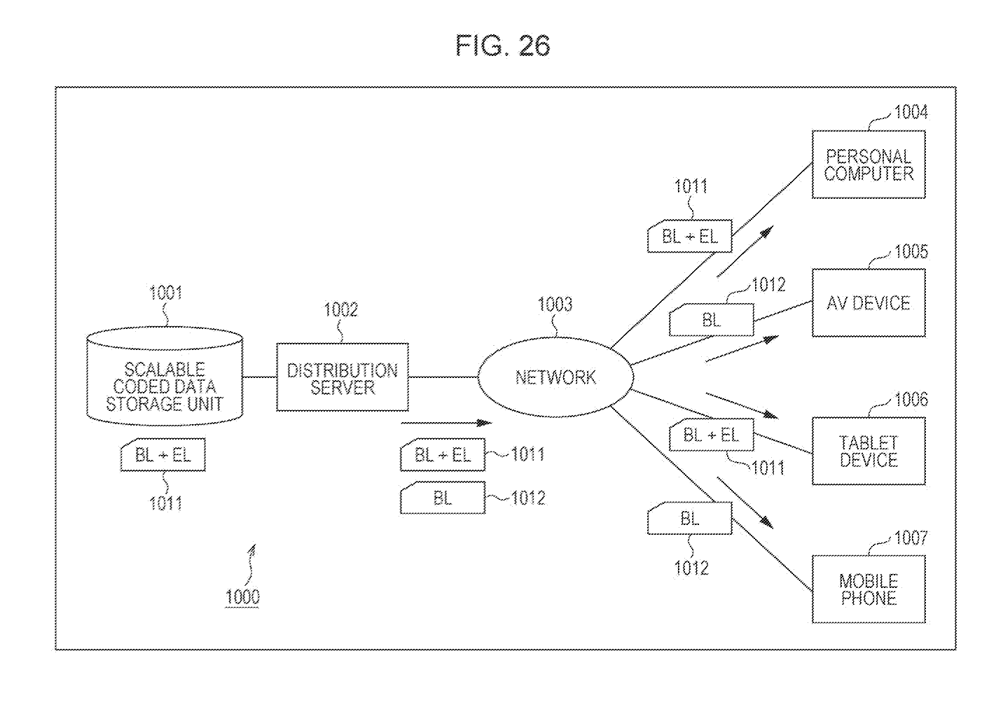

Next, a specific example of using scalable coded data, in which a scalable coding (hierarchical coding) is performed, will be described. The scalable coding is used for selection of data to be transmitted as examples illustrated in FIG. 26, for example.

In a data transmission system 1000 illustrated in FIG. 26, a distribution server 1002 reads scalable coded data stored in a scalable coded data storage unit 1001, and distributes the scalable coded data to a personal computer 1004, an AV device 1005, a tablet device 1006, and a mobile phone 1007 via a network 1003.

At this time, the distribution server 1002 selects and transmits coded data having a proper quality according to ability of a terminal device or communication environment. Even though the distribution server 1002 transmits unnecessarily high quality data, a high quality image is obtainable in the terminal device, but there is a concern that it may be a cause of occurrence of a delay or an overloading. In addition, there is also a concern that a communication band is unnecessarily occupied, or a load of the terminal device is unnecessarily increased. In reverse, even when the distribution server 1002 transmits unnecessarily low quality data, there is a concern that an image with a sufficient quality cannot be obtained. For this reason, the distribution server 1002 appropriately reads and transmits the scalable coded data stored in the scalable coded data storage unit 1001 as the coded data having a proper quality according to ability of a terminal device or communication environment.

For example, the scalable coded data storage unit 1001 stores scalable coded data (BL+EL) 1011 in which the scalable coding is performed. The scalable coded data (BL+EL) 1011 is coded data that includes both a base layer and an enhancement layer, and is data from which a base layer image and an enhancement layer image can be obtained by decoding the scalable coded data (BL+EL) 1011.

The distribution server 1002 selects an appropriate layer according to ability of a terminal device or communication environment, and reads the data of the selected layer. For example, with respect to the personal computer 1004 or the tablet device 1006 that has high processing ability, the distribution server 1002 reads the scalable coded data (BL+EL) 1011 from the scalable coded data storage unit 1001, and transmits the scalable coded data (BL+EL) 1011 as it is. Conversely, for example, with respect to the AV device 1005 or the mobile phone 1007 that has low processing ability, the distribution server 1002 extracts the data of the base layer from the scalable coded data (BL+EL) 1011, and transmits the extracted data of the base layer as low quality scalable coded data (BL) 1012 that is data having the same content as the scalable coded data (BL+EL) 1011 but having a lower quality than the scalable coded data (BL+EL) 1011.

An amount of data can easily be adjusted by utilizing the scalable coded data, the delay or the overloading can be suppressed, and the unnecessary increase of the loading of the terminal device or the communication media can be suppressed. In addition, in the scalable coded data (BL+EL) 1011, since a redundancy between the layers is reduced, it is possible to reduce the amount of data to be less than that in a case where the coded data of each layer is treated as the individual data. Therefore, it is possible to use the storage region of the scalable coded data storage unit 1001 with a high efficiency.

Since various apparatuses such as the personal computer 1004 to the mobile phone 1007 are applicable as the terminal device, the hardware performance of the terminal devices is different depending on the device. In addition, since there are various applications which are executed by the terminal device, the software performance thereof also varies. Further, since all the communication networks including a wired, wireless, or both such as internet and local area network (LAN) are applicable as the network 1003 that becomes a communication network, the data transmission performance thereof varies. Further, there is a concern that the data transmission performance may vary by other communications, or the like.

Therefore, the distribution server 1002 may perform communications with the terminal device which is the transmission destination before starting the data transmission, and then may obtain information related to the terminal device performance such as a hardware performance of the terminal device, or the application (software) performance which is executed by the terminal device, and information related to the communication environment such as a usable bandwidth of the network 1003. Then, distribution server 1002 may select an appropriate layer based on the obtained information.

The extraction of the layer may be performed in the terminal device. For example, the personal computer 1004 may decode the transmitted scalable coded data (BL+EL) 1011 and may display the image of the base layer, or may display the image of the enhancement layer. In addition, for example, the personal computer 1004 may extract the scalable coded data (BL) 1012 of the base layer from the transmitted scalable coded data (BL+EL) 1011, and may store the extracted scalable coded data (BL) 1012 of the base layer, transmit to another apparatus, or decode and display the image of the base layer.

Of course, the number of the scalable coded data storage units 1001, the distribution servers 1002, the networks 1003, and the terminal devices are optional. In addition, the example of the distribution server 1002 transmitting the data to the terminal device is described above. However, the example of use is not limited thereto. Any arbitrary system may be applied as the data transmission system 1000 as far as the system selects and transmits an appropriate layer according to the terminal device performance or the communication environment at the time when the scalable coded data is transmitted to the terminal device.

In the data transmission system 1000 as in FIG. 26 as well, it is possible to obtain the effect similar to the effect described above with reference to FIG. 18 to FIG. 20 by applying the present technology similar to the application to the hierarchical coding and decoding described above with reference to FIG. 18 to FIG. 20.

### <Second System>

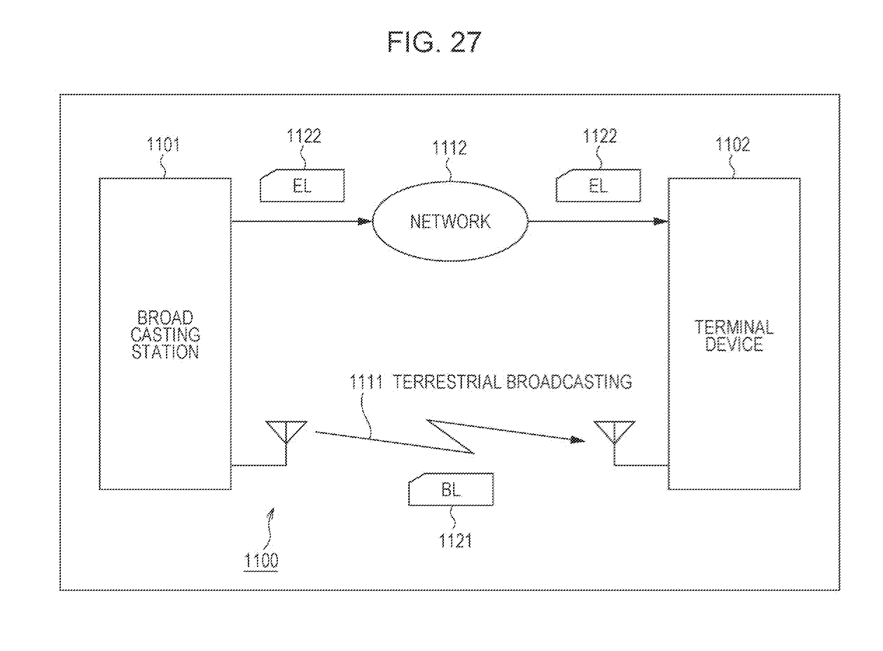

In addition, the scalable coding, for example, is used for transmission via a plurality of communication media as in an example illustrated in FIG. 27.

In a data transmission system 1100 illustrated in FIG. 27, a broadcasting station 1101 transmits scalable coded data (BL) 1121 of the base layer by a terrestrial broadcasting 1111. In addition, the broadcasting station 1101 transmits scalable coded data (EL) 1122 of the enhancement layer via any arbitrary network 1112 made of a communication network that is wired, wireless, or both. (For example, a packet transmission).

A terminal device 1102 has a function of receiving the terrestrial broadcasting 1111 that is broadcasted by the broadcasting station 1101 and receives the scalable coded data (BL) 1121 of the base layer transmitted via the terrestrial broadcasting 1111. In addition, the terminal device 1102 further has a communication function by which the communication is performed via the network 1112, and receives the scalable coded data (EL) 1122 of the enhancement layer transmitted via the network 1112.

The terminal device 1102, for example, according to a user's instruction, decodes the scalable coded data (BL) 1121 of the base layer acquired via the terrestrial broadcasting 1111, and obtains, stores, and transmits the image of the base layer to other devices.

In addition, the terminal device 1102, for example, according to a user's instruction, synthesizes the scalable coded data (BL) 1121 of the base layer acquired via the terrestrial broadcasting 1111 and the scalable coded data (EL) 1122 of the enhancement layer acquired via the network 1112, obtains the scalable coded data (BL+EL), and obtains, stores, and transmits the image of the enhancement layer by decoding the scalable coded data (BL+EL) to other devices.

As described above, the scalable coded data, for example, can be transmitted via the different communication media for each layer. Therefore, the loading can be dispersed and it is possible to suppress the occurrence of the delay or the over loading.

In addition, according to the situation, it may be possible to select the communication media used for the transmission for each layer. For example, the scalable coded data (BL) 1121 of the base layer in which the amount of data is comparatively large may be transmitted via the communication media having a wide bandwidth, and the scalable coded data (EL) 1122 of the enhancement layer in which the amount of data is comparatively small may be transmitted via the communication media having a narrow bandwidth. In addition, for example, whether the communication media that transmits the scalable coded data (EL) 1122 of the enhancement layer is the network 1112 or the terrestrial broadcasting 1111 may be switched according to the usable bandwidth of the network 1112. Of course, it is similar to the data of any arbitrary layer.

By controlling in this way, it is possible to further suppress the increase of the loading in the data transmission.

Of course, the number of the layers is optional, and the number of communication media used in the transmission is optional. In addition, the number of terminal devices 1102 which are the destination of the data distribution is also optional. Further, the example of the broadcasting from the broadcasting station 1101 is described above. However, the example of using is not limited thereto. Any arbitrary system may be applied as the data transmission system 1100 as far as the system divides the scalable coded data as the unit of layers, and transmits the scalable coded data via a plurality of lines.

In the data transmission system 1100 as in FIG. 27 as well, it is possible to obtain the effect similar to the effect described above with reference to FIG. 18 to FIG. 20 by applying the present technology similar to the application to the hierarchical coding and decoding described above with reference to FIG. 18 to FIG. 20.

### <Third System>

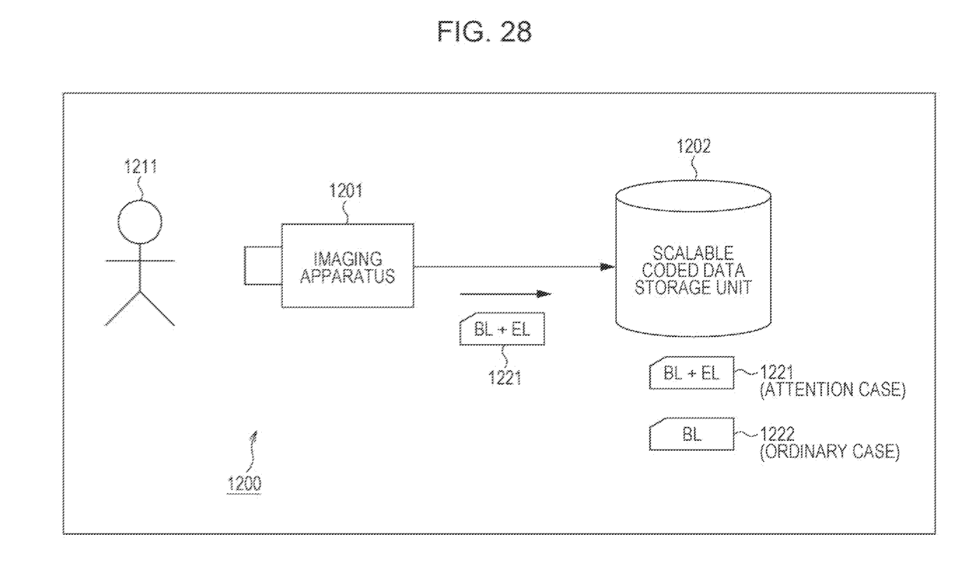

In addition, the scalable coding is used in the storage of the coded data as an example illustrated in FIG. 28.

In an imaging system 1200 illustrated in FIG. 28, an imaging apparatus 1201 performs a scalable coding on image data obtained by imaging a subject 1211, and supplies as the scalable coded data (BL+EL) 1221 to a scalable coded data storage unit 1202.

The scalable coded data storage unit 1202 stores the scalable coded data (BL+EL) 1221 supplied from the imaging apparatus 1201, with a quality according to the situation. For example, in an ordinary case, the scalable coded data storage unit 1202 extracts data of the base layer from the scalable coded data (BL+EL) 1221, and stores it as scalable coded data (BL) 1222 of the base layer having a low quality and small amount of data. Reversely, for example, in a case of interest, the scalable coded data storage unit 1202 stores the scalable coded data (BL+EL) 1221 having a high quality and large amount of data, as it is.

In this way, since the scalable coded data storage unit 1202 can keep the image in high quality only in a necessary case, it is possible to suppress the decrease of the value of the image due to the deterioration of the image quality and suppress the increase of the amount of the data, and it is possible to improve the utilization efficiency of the storage region.

For example, the imaging apparatus 1201 is assumed to be a motoring camera. In a case where a monitoring subject (for example, an invader) is not reflected on the imaged image (in an ordinary case), since content of the imaged image is possibly not important, the priority is on the reduction of the amount of data, and the image data (scalable coded data) is stored at low quality. Reversely, in a case where a monitoring subject is reflected as the subject 1211 on the imaged image (in a case of interest), since the content of the imaged image is possibly important, the priority is on the image quality, and the image data (scalable coded data) is stored at high quality.

Whether it is the ordinary case or the case of interest may be determined by the scalable coded data storage unit 1202 by analyzing the image. In addition, the imaging apparatus 1201 may determine the cases and may transmit the determination result to the scalable coded data storage unit 1202.

Determination criteria whether it is the ordinary case or the case of interest are optional and the content of the image which is the determination criteria is optional. Of course, a condition other than the content of the image can be the determination criteria. For example, the cases may be switched according to the size or the waveform of the recorded voice, may be switched by a predetermined time interval, or may be switched by an external instruction such as a user's instruction.

In addition, the two states of the ordinary case and the case of interest is described above. However, the number of the states is optional, and for example, the states may be switched in three or more states such as the ordinary case, the case of interest, and a case of high interest. However, the maximum number of states to be switched depends upon the number of layers of the scalable coded data.

In addition, the imaging apparatus 1201 may determine the number of layers of the scalable coding according to the state. For example, in the ordinary case, the imaging apparatus 1201 may generate the scalable coded data (BL) 1222 of the base layer having a low image quality and small amount of data, and may supply the data to the scalable coded data storage unit 1202. In addition, for example, in the case of interest, the imaging apparatus 1201 may generate the scalable coded data (BL+EL) 1221 of the base layer having a high image quality and large amount of data, and may supply the data to the scalable coded data storage unit 1202.

In the above description, the monitoring camera is described as the example. However, the usage of the imaging system 1200 is optional, but not limited to the monitoring camera.

In the imaging system 1200 as in FIG. 28 as well, it is possible to obtain the effect similar to the effect described above with reference to FIG. 18 to FIG. 20 by applying the present technology similar to the application to the hierarchical coding and decoding described above with reference to FIG. 18 to FIG. 20.

The present technology can be adapted to an HTTP streaming such as a MPEGDASH that selects an appropriate coded data in a unit of segment from a plurality of coded data which is prepared in advance and has different resolutions. That is, information related to the coding and decoding may be shared between the plurality of coded data.

In this Specification, the example in which the quantization parameter is transmitted from the coding side to the decoding side is described. In the method of transmitting the quantization matrix parameters, the parameter may be transmitted and recorded as a separate data associated with the coding bit stream without being multiplexed to the coding bit stream. Here, the term “associated with” means that the image included in the bit stream (may be a part of the image such as a slice or a block) and the information corresponding to the image can be linked. In other words, the information may be transmitted through a transmission path separate from that of the image (or the bit stream). In addition, the information may be recorded in a recording medium (or in the separate recording area in the same recording media) separate from that of the image (or the bit stream). Further, the information and the image (or the bit stream), for example, may be associated with each other in an arbitrary unit such as a plurality of frames, one frame, or a part within the frame.

The preferred embodiments of the present disclosure are described in detail as above with reference to the attached drawings. However, the technical scope of the present disclosure is not limited to the disclosed examples. It is apparent that anyone who has general knowledge in the technical field of the present disclosure can easily conceive of various examples of variations or modifications, and it is understood that those examples of variations or modifications also naturally fall within the technical scope of the present disclosure.

The present disclosure may be configured as follows.

(1) An image processing apparatus that includes:

an offset setting unit that sets an offset of a quantization parameter for a color difference signal based on a quantization parameter for a brightness signal according to a size or a shape of a unit of transform when an orthogonal transform is performed on image data; and

a quantization unit that quantizes an orthogonal transform coefficient of the image data using the quantization parameter for the color difference signal obtained from the quantization parameter for the brightness signal using the offset set by the offset setting unit.

(2) The image processing apparatus according to above (1), in which the offset setting unit sets the offset in such a manner that the quantization is performed by the finer quantization step with respect to a larger unit of the transform.

(3) The image processing apparatus according to above (2), in which the offset setting unit sets the offset of the larger unit of the transform to a smaller value.

(4) The image processing apparatus according to any of above (1) to (3), in which the offset setting unit sets the offset in such a manner that the quantization is performed by the finer quantization step with respect to the orthogonal transform coefficient having a size more likely to be referred to, according to a bit rate of coded data in which the image data is coded.

(5) The image processing apparatus according to any of above (1) to (4), in which the offset setting unit corrects an initial value of the offset determined in advance according to the size of the unit of transform.

(6) The image processing apparatus according to any of above (1) to (5), in which the offset setting unit sets the offset value with respect to a square unit of transform having a size same as or similar to the unit of transform as the offset with respect to the rectangular unit of transform.

(7) The image processing apparatus according to any of above (1) to (5), in which the offset setting unit sets the offset according to the size or shape of the unit of transform when the orthogonal transform is performed on image data.

(8) An image processing method by the image processing apparatus that includes:

setting an offset of a quantization parameter for a color difference signal based on a quantization parameter for a brightness signal according to a size or a shape of a unit of transform when an orthogonal transform is performed on image data, by an offset setting unit; and

quantizing an orthogonal transform coefficient of the image data using the quantization parameter for the color difference signal obtained from the quantization parameter for the brightness signal using the set offset, by a quantization unit.

(9) An image processing apparatus that includes:

an offset setting unit that sets an offset of a quantization parameter for a color difference signal based on a quantization parameter for a brightness signal according to a size or a shape of a unit of transform when an orthogonal transform is performed on image data; and

a reverse quantization unit that reverse quantizes a quantized orthogonal transform coefficient of the image data using the quantization parameter for the color difference signal obtained from the quantization parameter for the brightness signal using the offset set by the offset setting unit.

(10) An image processing method by an image processing apparatus, that includes:

setting an offset of a quantization parameter for a color difference signal based on a quantization parameter for a brightness signal according to a size or a shape of a unit of transform when an orthogonal transform is performed on image data, by an offset setting unit; and

reverse quantizing a quantized orthogonal transform coefficient of the image data using the quantization parameter for the color difference signal obtained from the quantization parameter for the brightness signal using the set offset, by a reverse quantization unit.

(11) An image processing apparatus that includes:

an offset setting unit that sets an offset of a quantization parameter for a color difference signal based on a quantization parameter for a brightness signal according to a size or a shape of a unit of transform when an orthogonal transform is performed on image data;

a coding unit that codes the image data; and

a transmission unit that transmits the offset set by the offset setting unit and coded data generated by the coding unit.

(12) The image processing apparatus according to above (11), in which the transmission unit transmits the offset set by the offset setting unit as a parameter set of the coded data.

(13) The image processing apparatus according to above (12), in which the transmission unit combines a plurality of offset set by the offset setting unit into a single set to transmit as the parameter set.

(14) The image processing apparatus according to above (13), in which the transmission unit transmits the offset set by the offset setting unit as a sequence parameter of the coded data.

(15) The image processing apparatus according to above (13) or (14), in which the transmission unit transmits the offset set by the offset setting unit as a picture parameter set of the coded data.

(16) The image processing apparatus according to any of above (13) to (15), in which the transmission unit transmits the offset set by the offset setting unit as an adaptation parameter set of the coded data.

(17) The image processing apparatus according to any of above (11) to (16), in which the transmission unit transmits the offset set by the offset setting unit as a slice header of the coded data.

(18) An image processing method by an image processing apparatus, that includes:

setting an offset of a quantization parameter for a color difference signal based on a quantization parameter for a brightness signal according to a size or shape of a unit of transform when an orthogonal transform is performed on image data, by an offset setting unit;

coding the image data by a coding unit; and

transmitting the set offset and generated coded data, by a transmission unit.

(19) An image processing apparatus that includes:

a receiving unit that receives an offset of a quantization parameter for a color difference signal based on a quantization parameter for a brightness signal, which is set according to a size or a shape of a unit of transform when an orthogonal transform is performed on image data, and coded data in which the image data is coded;

a decoding unit that decodes the coded data received by the receiving unit; and

a reverse quantization unit that reverse quantizes a quantized orthogonal transform coefficient of the image data obtained by the coded data being decoded by the decoding unit, using the quantization parameter for the color difference signal obtained from the quantization parameter for the brightness signal using the offset extracted from the coded data received by the receiving unit.

(20) An image processing method by an image processing apparatus, that includes:

receiving an offset of a quantization parameter for a color difference signal based on a quantization parameter for a brightness signal, which is set according to a size or a shape of a unit of transform when an orthogonal transform is performed on image data, and coded data in which the image data is coded, by a receiving unit;

decoding the received coded data, by a decoding unit; and

reverse quantizing a quantized orthogonal transform coefficient of the image data obtained by the coded data being decoded by the decoding unit, using the quantization parameter for the color difference signal obtained from the quantization parameter for the brightness signal using the offset extracted from the received coded data, by a reverse quantization unit.

### REFERENCE SIGNS LIST

100 image coding apparatus, 121 color difference quantization offset setting unit, 151 4×4 orthogonal transform unit, 152 8×8 orthogonal transform unit, 153 16×16 orthogonal transform unit, 154 4×4 cost function calculation unit, 155 8×8 cost function calculation unit, 156 16×16 cost function calculation unit, 157 TU size determination unit, 171 color difference quantization value determination unit, 172 quantization processing unit, 200 image decoding apparatus, 221 color difference quantization offset unit, 251 color difference quantization value determination unit, 252 reverse quantization processing unit

1. An image processing apparatus comprising:
an offset setting unit that sets an offset of a quantization parameter for a color difference signal based on a quantization parameter for a brightness signal according to a size or a shape of a unit of transform when an orthogonal transform is performed on image data; and
a quantization unit that quantizes an orthogonal transform coefficient of the image data using the quantization parameter for the color difference signal obtained from the quantization parameter for the brightness signal using the offset set by the offset setting unit.

2. The image processing apparatus according to claim 1,
wherein the offset setting unit sets the offset in such a manner that the quantization is performed by the finer quantization step with respect to a larger unit of the transform.

3. The image processing apparatus according to claim 2,
wherein the offset setting unit sets the offset of the larger unit of the transform to a smaller value.

4. The image processing apparatus according to claim 1,
wherein, according to a bit rate of coded data in which the image data is coded, the offset setting unit sets the offset in such a manner that the quantization is performed by the finer quantization step with respect to the orthogonal transform coefficient having a size more likely to be referred to.

5. The image processing apparatus according to claim 1,
wherein the offset setting unit corrects an initial value of the offset determined in advance according to the size of the unit of transform.

6. The image processing apparatus according to claim 1,
wherein the offset setting unit sets the offset value with respect to a square unit of transform having a size same as or similar to the unit of transform as the offset with respect to the rectangular unit of transform.

7. The image processing apparatus according to claim 1,
wherein the offset setting unit sets the offset according to the size or shape of the unit of transform when the orthogonal transform is performed on image data.

8. An image processing method by the image processing apparatus, comprising:
setting an offset of a quantization parameter for a color difference signal based on a quantization parameter for a brightness signal according to a size or a shape of a unit of transform when an orthogonal transform is performed on image data, by an offset setting unit; and
quantizing an orthogonal transform coefficient of the image data using the quantization parameter for the color difference signal obtained from the quantization parameter for the brightness signal using the set offset, by a quantization unit.

9. An image processing apparatus, comprising:
an offset setting unit that sets an offset of a quantization parameter for a color difference signal based on a quantization parameter for a brightness signal according to a size or a shape of a unit of transform when an orthogonal transform is performed on image data; and
a reverse quantization unit that reverse quantizes a quantized orthogonal transform coefficient of the image data using the quantization parameter for the color difference signal obtained from the quantization parameter for the brightness signal using the offset set by the offset setting unit.

10. An image processing method by an image processing apparatus, comprising:
setting an offset of a quantization parameter for a color difference signal based on a quantization parameter for a brightness signal according to a size or a shape of a unit of transform when an orthogonal transform is performed on image data, by an offset setting unit; and
reverse quantizing a quantized orthogonal transform coefficient of the image data using the quantization parameter for the color difference signal obtained from the quantization parameter for the brightness signal using the set offset, by a reverse quantization unit.

11. An image processing apparatus, comprising:
an offset setting unit that sets an offset of a quantization parameter for a color difference signal based on a quantization parameter for a brightness signal according to a size or a shape of a unit of transform when an orthogonal transform is performed on image data;
a coding unit that codes the image data; and
a transmission unit that transmits the offset set by the offset setting unit and coded data generated by the coding unit.

12. The image processing apparatus according to claim 11,
wherein the transmission unit transmits the offset set by the offset setting unit as a parameter set of the coded data.

13. The image processing apparatus according to claim 12,
wherein the transmission unit combines a plurality of offsets set by the offset setting unit into a single set to transmit as the parameter set.

14. The image processing apparatus according to claim 13,
wherein the transmission unit transmits the offset set by the offset setting unit as a sequence parameter of the coded data.

15. The image processing apparatus according to claim 13,
wherein the transmission unit transmits the offset set by the offset setting unit as a picture parameter set of the coded data.

16. The image processing apparatus according to claim 13,
wherein the transmission unit transmits the offset set by the offset setting unit as an adaptation parameter set of the coded data.

17. The image processing apparatus according to claim 11,
wherein the transmission unit transmits the offset set by the offset setting unit as a slice header of the coded data.

18. An image processing method by an image processing apparatus, comprising:
setting an offset of a quantization parameter for a color difference signal based on a quantization parameter for a brightness signal according to a size or shape of a unit of transform when an orthogonal transform is performed on image data, by an offset setting unit;
coding the image data by a coding unit; and
transmitting the set offset and the generated coded data, by a transmission unit.

19. An image processing apparatus, comprising:
a receiving unit that receives an offset of a quantization parameter for a color difference signal based on a quantization parameter for a brightness signal, which is set according to a size or a shape of a unit of transform when an orthogonal transform is performed on image data, and coded data in which the image data is coded;
a decoding unit that decodes the coded data received by the receiving unit; and
a reverse quantization unit that reverse quantizes a quantized orthogonal transform coefficient of the image data obtained by the coded data being decoded by the decoding unit, using the quantization parameter for the color difference signal obtained from the quantization parameter for the brightness signal using the offset extracted from the coded data received by the receiving unit.

20. An image processing method by an image processing apparatus, comprising:
receiving an offset of a quantization parameter for a color difference signal based on a quantization parameter for a brightness signal, which is set according to a size or a shape of a unit of transform when an orthogonal transform is performed on image data, and coded data in which the image data is coded, by a receiving unit;
decoding the received coded data, by a decoding unit; and
reverse quantizing a quantized orthogonal transform coefficient of the image data obtained by the coded data being decoded by the decoding unit, using the quantization parameter for the color difference signal obtained from the quantization parameter for the brightness signal using the offset extracted from the received coded data, by a reverse quantization unit.
